(19) United States
(12) Patent Application Publication
(10) Pub. No.: US 2025/0324207 A1
(43) Pub. Date: Oct. 16, 2025

(54) EAR-WORN ELECTRONIC HEARING DEVICE INCORPORATING AN ANTENNA WITH CUTOUTS

(71) Applicant: Starkey Laboratories, Inc., Eden Prairie, MN (US)

(72) Inventors: Danita Prabhu, Minneapolis, MN (US); Ryan Owens, Hopkins, MN (US); Aaron Anderson, Mayer, MN (US); Paul Anders Shriner, Hopkins, MN (US)

(21) Appl. No.: 19/192,122

(22) Filed: Apr. 28, 2025

Related U.S. Application Data
(63) Continuation of application No. 18/402,284, filed on Jan. 2, 2024, now Pat. No. 12,317,038.
Application No. 18/402,284 is a continuation of application No. 17/821,059, filed on Aug. 19, 2022, now Pat. No. 11,902,748.
Application No. 17/821,059 is a continuation of application No. 17/027,129, filed on Sep. 21, 2020, now Pat. No. 11,425,512.
Application No. 17/027,129 is a continuation of application No. 16/214,901, filed on Dec. 10, 2018, now Pat. No. 10,785,582.
Application No. 16/214,901 is a continuation-in-part of application No. 16/057,177, filed on Aug. 7, 2018, now Pat. No. 10,951,997.

(51) Int. Cl. H04R 25/00

(52) U.S. Cl. CPC H04R 25/554; H04R 25/65; H04R 2225/51; H04R 2225/55

(57) ABSTRACT

An ear-worn electronic hearing device comprises an enclosure configured to be supported by, at, in or on an ear of the wearer. Electronic circuitry is disposed in the enclosure and comprises a wireless transceiver. An antenna is disposed in or on the enclosure and operably coupled to the wireless transceiver. The antenna has a physical size and comprises a plurality of cutouts disposed along a periphery of the antenna. The cutouts are configured to increase an electrical length of the antenna without an increase in the physical size of the antenna. The antenna can comprise at least one interior window having a window periphery. A plurality of window cutouts are disposed along the window periphery. The window cutouts are configured to increase a path length of current distribution along the window periphery.

This application is a continuation of U.S. patent application Ser. No. 18/402,284, filed Jan. 2, 2024 which is a continuation of U.S. patent application Ser. No. 17/821,059, filed Aug. 19, 2022 (now issued as U.S. Pat. No. 11,902,748). U.S. patent application Ser. No. 17/821,059 is a continuation of U.S. patent application Ser. No. 17/027,129, filed Sep. 21, 2020 (now issued as U.S. Pat. No. 11,425,512) which is a continuation of U.S. patent application Ser. No. 16/214,901, filed on Dec. 10, 2018 (now issued as U.S. Pat. No. 10,785,582) and also a continuation-in-part of U.S. patent application Ser. No. 16/057,177, filed Aug. 7, 2018 (now issued as U.S. Pat. No. 10,951,997). The entire contents of each of U.S. patent applications Ser. Nos. 18/402,284, 17/821,059, 17/027,129, 16/214,901, and 16/057,177 are incorporated herein by reference.

### TECHNICAL FIELD

This application relates generally to ear-worn electronic hearing devices including hearing aids, personal amplification devices, and other hearables.

### BACKGROUND

Hearing devices provide sound for the wearer. Some examples of hearing devices are headsets, hearing aids, speakers, cochlear implants, bone conduction devices, and personal listening devices. For example, hearing aids provide amplification to compensate for hearing loss by transmitting amplified sounds to a wearer's ear drums. Hearing devices may be capable of performing wireless communication with other devices, such as receiving streaming audio from a streaming device via a wireless link. Wireless communication may also be performed for programming the hearing device and transmitting information from the hearing device. For performing such wireless communication, hearing devices can include a wireless transceiver and an antenna.

### SUMMARY

Embodiments are directed to an ear-worn electronic hearing device configured to be worn by a wearer. The hearing device comprises an enclosure configured to be supported by, at, in or on an ear of the wearer. Electronic circuitry is disposed in the enclosure and comprises a wireless transceiver. An antenna is disposed in or on the enclosure and operably coupled to the wireless transceiver. The antenna has a physical size and comprises a plurality of cutouts disposed along a periphery of the antenna. The cutouts are configured to increase an electrical length of the antenna without an increase in the physical size of the antenna. In some embodiments, the antenna comprises at least one interior window having a window periphery. A plurality of window cutouts are disposed along the window periphery. The window cutouts are configured to increase a path length of current distribution along the window periphery.

Embodiments are directed to an ear-worn electronic hearing device configured to be worn by a wearer. The hearing device comprises an enclosure configured to be supported by, at, in or on an ear of the wearer. Electronic circuitry is disposed in the enclosure and comprises a wireless transceiver. An antenna is disposed in or on the enclosure and operably coupled to the wireless transceiver. The antenna has a physical size and comprises two antenna elements each comprising electrically conductive material and oriented substantially in opposition to one another. At least some of the electronic circuitry is disposed between the two antenna elements. At least one strap is connected to and between the two antenna elements. A plurality of cutouts are disposed along a periphery of the two antenna elements. The cutouts are configured to increase an electrical length of the antenna without an increase in the physical size of the antenna. In some embodiments, one or both of the two antenna elements comprises at least one interior window having a window periphery. A plurality of window cutouts are disposed along the window periphery. The window cutouts are configured to increase a path length of current distribution along the window periphery.

Embodiments are directed to an ear-worn electronic hearing device configured to be worn by a wearer. The hearing device comprises an enclosure configured to be supported by, at, in or on an ear of the wearer. Electronic circuitry is disposed in the enclosure and comprises a wireless transceiver. An antenna is disposed in or on the enclosure and operably coupled to the wireless transceiver. The antenna has a physical size and comprises at least one interior window having a window periphery. A plurality of window cutouts are disposed along the window periphery. The window cutouts are configured to increase a path length of current distribution along the window periphery and increase an electrical length of the antenna without an increase in the physical size of the antenna. In some embodiments, the antenna comprises two antenna elements each comprising electrically conductive material and oriented substantially in opposition to one another. At least some of the electronic circuitry is disposed between the two antenna elements. At least one strap is connected to and between the two antenna elements. Each of the two antenna elements comprises at least one of the interior windows.

Embodiments are directed to an ear-worn electronic device configured to be worn by a wearer and comprising an enclosure configured to be supported by, in or on an ear of the wearer. Electronic circuitry is disposed in the enclosure and comprises a wireless transceiver. An antenna is disposed in or on the enclosure and coupled to the wireless transceiver via a feedline. The antenna comprises two antenna elements each comprising electrically conductive material and having an area greater than an area of the feedline. The two antenna elements are oriented substantially in opposition to one another and at least some of the electronic circuitry is disposed between the two antenna elements. At least one strap is connected to and between the two antenna elements. At least one slot radiating element is incorporated in at least one of the two antenna elements and the at least one strap.

Embodiments are directed to an ear-worn electronic device configured to be worn by a wearer and comprising an enclosure configured to be supported by, in or on an ear of the wearer. Electronic circuitry is disposed in the enclosure and comprises a wireless transceiver. An antenna is disposed in or on the enclosure and coupled to the wireless transceiver via a feedline. The antenna comprises two operably coupled antenna elements each comprising electrically conductive material and having an area greater than an area of the feedline. The two antenna elements are oriented substantially in opposition to one another and at least some of the electronic circuitry disposed between the two antenna elements. At least one slot radiating element is incorporated in at least one of the two antenna elements and configured such that excitation of the antenna excites a slot mode of the at least one slot radiating element.

The above summary is not intended to describe each disclosed embodiment or every implementation of the present disclosure. The figures and the detailed description below more particularly exemplify illustrative embodiments.

### BRIEF DESCRIPTION OF THE DRAWINGS

Throughout the specification reference is made to the appended drawings wherein:

FIG. 1 illustrates various components of a representative hearing device in accordance with various embodiments;

FIG. 2 shows cutouts provided along a periphery of the antenna and/or along the periphery of one or more interior windows of the antenna in accordance with various embodiments;

FIG. 3 illustrates a hearing device configured to incorporate an antenna with cutouts in accordance with various embodiments;

FIG. 4 is a perspective view of an antenna of a hearing device which incorporates a plurality of cutouts disposed along a periphery of the antenna in accordance with various embodiments;

FIG. 5 is a view of a portion of an antenna having a periphery which includes a plurality of cutouts in accordance with various embodiments;

FIG. 6 is a perspective view of an antenna of a hearing device which incorporates a plurality of cutouts disposed along a periphery of the antenna in accordance with various embodiments;

FIGS. 7A-7C show a portion of an antenna which includes differently shaped polygonal cutouts disposed along a periphery of the antenna in accordance with various embodiments;

FIGS. 8A and 8B show a portion of an antenna which includes differently shaped curved or curvilinear cutouts disposed along a periphery of the antenna in accordance with various embodiments;

FIG. 9A is a perspective view of an antenna of a hearing device which incorporates one or more interior windows comprising a plurality of window cutouts in accordance with various embodiments;

FIG. 9B is a view of an interior window shown in FIG. 9A comprising a plurality of window cutouts in accordance with various embodiments; and

FIG. 10 is a graph showing an improvement in radiation efficiency for a hearing device equipped with an antenna comprising peripheral cutouts in comparison to a hearing device equipped with an antenna devoid of peripheral cutouts.

FIGS. 11A and 11B illustrate a hearing device arrangement adapted to be worn at an ear of a wearer and incorporates an antenna comprising one or more slot radiating elements in accordance with various embodiments;

FIGS. 12A and 12B illustrate a hearing device which incorporates an antenna comprising one or more slot radiating elements in accordance with various embodiments;

FIG. 13 illustrates an antenna which includes one or more slot radiating elements in accordance with various embodiments;

FIG. 14 illustrates an antenna which includes one or more slot radiating elements in accordance with various embodiments;

FIG. 15 illustrates an antenna which includes one or more slot radiating elements in accordance with various embodiments;

FIG. 16 illustrates an antenna which includes one or more slot radiating elements in accordance with various embodiments;

FIG. 17 illustrates an antenna which includes slot radiating elements in accordance with various embodiments;

FIGS. 18A and 18B illustrate an antenna which includes slot radiating elements in accordance with various embodiments;

FIGS. 19A and 19B illustrate an antenna which includes slot radiating elements in accordance with various embodiments;

FIG. 20 illustrates an antenna which includes slot radiating elements in accordance with various embodiments;

FIG. 21 illustrates an antenna which includes slot radiating elements in accordance with various embodiments;

FIG. 22 illustrates an antenna which includes slot radiating elements filled with dielectric or magnetic material in accordance with various embodiments;

FIG. 23 shows a slot radiating element incorporated in an antenna having a rectangular shape with electric and magnetic fields illustrated within the slot in accordance with various embodiments;

FIG. 24 shows a slot radiating element incorporated in an antenna having a rectangular shape with electric and magnetic fields illustrated within the slot in accordance with various embodiments; and

FIG. 25 shows a slot radiating element incorporated in an antenna having a rectangular shape with electric and magnetic fields illustrated within the slot in accordance with various embodiments.

The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

It is understood that the embodiments described herein may be used with any ear-worn electronic hearing device without departing from the scope of this disclosure. The devices depicted in the figures are intended to demonstrate the subject matter, but not in a limited, exhaustive, or exclusive sense. Ear-worn electronic hearing devices (referred to herein as “hearing devices”), such as hearables (e.g., wearable earphones, ear monitors, and earbuds), hearing aids, hearing instruments, and hearing assistance devices, typically include an enclosure, such as a housing or shell, within which internal components are disposed. Typical components of a hearing device can include a processor (e.g., a digital signal processor or DSP), memory circuitry, power management circuitry, one or more communication devices (e.g., a radio, a near-field magnetic induction (NFMI) device), one or more antennas, one or more microphones, and a receiver/speaker, for example. Hearing devices can incorporate a long-range communication device, such as a Bluetooth® transceiver or other type of radio frequency (RF) transceiver. A communication device (e.g., a radio or NFMI device) of a hearing device can be configured to facilitate communication between a left ear device and a right ear device of the hearing device.

Hearing devices of the present disclosure can incorporate an antenna coupled to a high-frequency transceiver, such as a 2.4 GHz radio. The RF transceiver can conform to an IEEE 802.11 (e.g., WiFi®) or Bluetooth® (e.g., BLE, Bluetooth® 4.2 or 5.0) specification, for example. It is understood that hearing devices of the present disclosure can employ other transceivers or radios, such as a 900 MHz radio. Hearing devices of the present disclosure can be configured to receive streaming audio (e.g., digital audio data or files) from an electronic or digital source. Representative electronic/digital sources (e.g., accessory devices) include an assistive listening system, a TV streamer, a radio, a smartphone, a laptop, a cell phone/entertainment device (CPED) or other electronic device that serves as a source of digital audio data or other types of data files. Hearing devices of the present disclosure can be configured to effect bi-directional communication (e.g., wireless communication) of data with an external source, such as a remote server via the Internet or other communication infrastructure. Hearing devices that include a left ear device and a right ear device can be configured to effect bi-directional communication (e.g., wireless communication) therebetween, so as to implement ear-to-ear communication between the left and right ear devices.

The term hearing device of the present disclosure refers to a wide variety of ear-level electronic devices that can aid a person with impaired hearing. The term hearing device also refers to a wide variety of devices that can produce processed sound for persons with normal hearing. Hearing devices of the present disclosure include hearables (e.g., wearable earphones, headphones, earbuds, virtual reality headsets), hearing aids (e.g., hearing instruments), cochlear implants, and bone-conduction devices, for example. Hearing devices include, but are not limited to, behind-the-ear (BTE), in-the-ear (ITE), in-the-canal (ITC), invisible-in-canal (IIC), receiver-in-canal (RIC), receiver-in-the-ear (RITE) or completely-in- the-canal (CIC) type hearing devices or some combination of the above. Throughout this disclosure, reference is made to a “hearing device,” which is understood to refer to a system comprising a single left ear device, a single right ear device, or a combination of a left ear device and a right ear device.

Advancements in hearing device technology have resulted in a reduction in the overall size of hearing devices and/or the available internal space due to the desire to incorporate a greater number of components that provide for a greater array of capabilities. For hearing devices that incorporate an RF antenna, a reduction in the physical size of the antenna diminishes the overall performance of the antenna. Several problems arise when designing a small RF antenna, such as one that operates over the 2.4 GHz ISM band. A first problem concerns low feed point impedance. A second problem concerns an inability to meet total radiated power (TRP) requirements due to low radiation efficiency. A third problem concerns a frequency bandwidth that is too narrow to operate over the 2.4 GHz ISM band. Embodiments of the disclosure are directed to an ear-worn electronic hearing device which incorporates an antenna that overcomes the problems listed above and provides for enhanced antenna performance.

A hearing device according to various embodiments comprises an enclosure configured to be supported by, at, in or on an ear of the wearer. Electronic circuitry is disposed in the enclosure and comprises a wireless transceiver. An antenna is disposed in or on the enclosure and operably coupled to the wireless transceiver. The antenna comprises a multiplicity of cutouts along the antenna periphery and/or along a periphery of one or more interior windows that provide for enhanced antenna performance. In some embodiments, the antenna includes a single antenna element provided with cutouts along the antenna periphery and/or along a periphery of one or more interior windows. In other embodiments, the antenna includes two or more antenna elements each provided with cutouts along the antenna periphery and/or along a periphery of one or more interior windows. Incorporation of antenna cutouts in accordance with the present disclosure provides for a hearing device antenna with improved radiation efficiency as well as an increased impedance bandwidth. Incorporation of antenna cutouts in accordance with the present disclosure serves to increase the electrical length of the antenna without increasing the physical size of the antenna, which is particularly advantageous for small hearing devices.

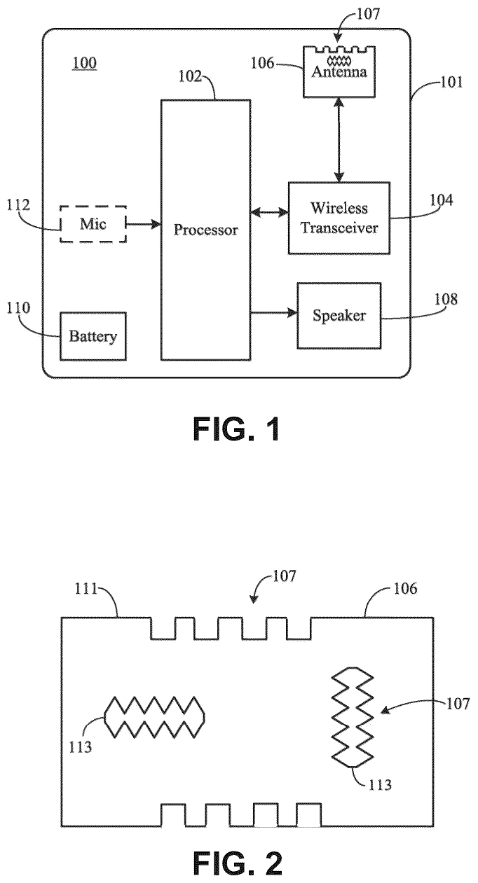

FIG. 1 illustrates various components of a representative hearing device in accordance with various embodiments. FIG. 1 illustrates a hearing device 100 configured to be supported at, by, in or on a left ear or a right ear of a wearer. Typically, two hearing devices 100 (left and right) are worn by a wearer, both of which include the components shown in FIG. 1. It is understood that left and right hearing devices can include different functional components. The hearing device 100 can be representative of any of the hearing devices disclosed herein.

The hearing device 100 includes an enclosure 101 configured for placement, for example, over or on the ear, entirely or partially within the external ear canal (e.g., between the pinna and ear drum) or behind the ear. Disposed within the enclosure 101 is a processor 102 which incorporates or is coupled to memory circuitry. The processor 102 can include or be implemented as a multi-core processor, a digital signal processor (DSP), an audio processor or a combination of these processors. For example, the processor 102 may be implemented in a variety of different ways, such as with a mixture of discrete analog and digital components that include a processor configured to execute programmed instructions contained in a processor-readable storage medium (e.g., solid-state memory, Flash).

The processor 102 is coupled to a wireless transceiver 104 (also referred to herein as a radio), such as a BLE transceiver. The wireless transceiver 104 is operably coupled to an antenna 106 configured for transmitting and receiving radio signals. The antenna 106, according to various embodiments, includes a plurality of antenna cutouts 107 configured to enhance antenna performance. As will be described in greater detail, the cutouts 107 are configured to increase the electrical length of the antenna without an increase in the physical size of the antenna.

As is shown in FIG. 2, cutouts 107 can be provided along a periphery 111 of the antenna 106 according to various embodiments. In some embodiments, cutouts 107 can be provided along the periphery of one or more interior windows 113. In other embodiments, cutouts 107 can be provided along the antenna periphery 111 and along the periphery of one or more interior windows 113. The antenna 106 can be any type of antenna suitable for incorporation in the hearing device 100, several representative examples of which are described hereinbelow.

The wireless transceiver 104 and antenna 106 can be configured to enable ear-to-ear communication between two hearing devices 100, as well as communications with an external device (e.g., a smartphone or a digital music player). A battery 110 or other power source (rechargeable or conventional) is provided within the enclosure 101 and is configured to provide power to the various components of the hearing device 100. A speaker or receiver 108 is coupled to an amplifier (not shown) and the processor 102. The speaker or receiver 108 is configured to generate sound which is communicated to the wearer's ear drum.

In some embodiments, the hearing device 100 includes a microphone 112 mounted on or inside the enclosure 101. The microphone 112 may be a single microphone or multiple microphones, such as a microphone array. The microphone 112 can be coupled to a preamplifier (not shown), the output of which is coupled to the processor 102. The microphone 112 receives sound waves from the environment and converts the sound into an input signal. The input signal is amplified by the preamplifier and sampled and digitized by an analog-to-digital converter of the processor 102, resulting in a digitized input signal. In some embodiments (e.g., hearing aids), the processor 102 (e.g., DSP circuitry) is configured to process the digitized input signal into an output signal in a manner that compensates for the wearer's hearing loss. When receiving an audio signal from an external source, the wireless transceiver 104 may produce a second input signal for the DSP circuitry of the processor 102 that may be combined with the input signal produced by the microphone 112 or used in place thereof. In other embodiments, (e.g., hearables), the processor 102 can be configured to process the digitized input signal into an output signal in a manner that is tailored or optimized for the wearer (e.g., based on wearer preferences). The output signal is then passed to an audio output stage that drives the speaker or receiver 108, which converts the output signal into an audio output.

Some embodiments are directed to a custom hearing aid, such as an ITC, CIC, or IIC hearing aid, for example. For example, some embodiments are directed to a custom hearing aid which includes a wireless transceiver and an antenna arrangement configured to operate in the 2.4 GHz ISM frequency band (e.g., a Bluetooth® band). Creating a robust antenna arrangement for a 2.4 GHz custom hearing aid represents a significant engineering challenge. A custom hearing aid is severely limited in space, and the antenna arrangement is in close proximity to other electrical components, both of which impacts antenna performance. Because the human body is very lossy and a custom hearing aid is positioned within the ear canal, a high performance antenna arrangement is particularly desirable. The antenna 106 comprising cutouts 107 advantageously increases the electrical length of the antenna 106 without an increase in the size of the antenna 106, which is particularly important for custom hearing aids and other small hearing devices.

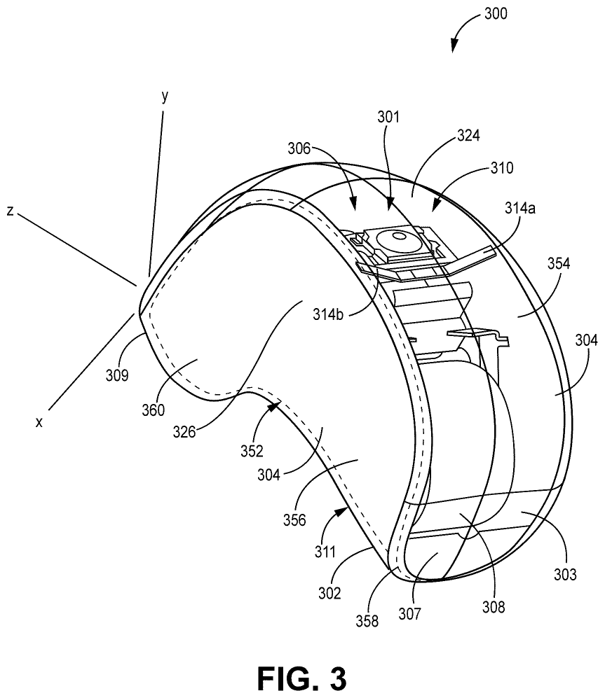

FIG. 3 illustrates a hearing device configured to incorporate an antenna with cutouts in accordance with various embodiments. In the embodiment shown in FIG. 3, the hearing device 300 is of a behind-the-ear design. The hearing device 300 includes an enclosure 302 in the form of a housing or shell, which includes a first end 307 and an opposing second end 309. The enclosure 302 also includes a bottom 311, a removable top or cap (removed in FIG. 3) opposing the bottom 311, and opposing sides 324 and 326, all of which extend between the first and second ends 307 and 309. A battery 308 is shown positioned proximate the first end 307. The first end 307 can be hingedly connected to the enclosure 302 or otherwise configured to move between closed and open positions for installing and removing the battery 308. A spine 310 extends longitudinally within the enclosure 302 between the battery 308 and the second end 309. The spine 310 is a structure inside the enclosure 302 that supports a flexible circuit substrate and electronics 306 of the hearing device 300. The spine 310 includes supports or struts that are connected to interior surfaces 303 of the enclosure 302 and positionally fix the spine 310 within the enclosure 302.

In the embodiment shown in FIG. 3, an antenna 304 (partially indicated by a dashed line) is disposed within or on the enclosure 302 and has a shape that generally conforms to a shape of the enclosure 302. As such, the shape of the antenna 304 generally follows the shape of the enclosure wall. Although not shown in FIG. 3, the antenna 304 can include any of the peripheral cutouts and/or interior window cutouts described hereinbelow. The antenna 304 can have a variety of configurations, examples of which are also described hereinbelow. For purposes of illustration and not of limitation, antenna 304 will be described as a folded antenna. In other embodiments, antenna 304 can be a bowtie or other type of antenna.

In some embodiments, the antenna 304 is a folded antenna having the general shape of a taco or saddle. The folded antenna 304 can have a generally U-shaped cross-section, for example. The folded antenna 304 can be a substantially solid, folded structure that extends longitudinally along interior surfaces 303 of the enclosure 302. The folded antenna 304 has a first end 358, a second and 360, and a belly 352 that extends axially between the first and second ends 358 and 360. The folded antenna 304 includes opposing first and second sides 354 and 356 that extend from the belly 352 at an angle (e.g., an acute angle). Depending on how the folded antenna 304 is oriented within the enclosure 302, the belly 352 can define a bottom or a top of the antenna 304. In the embodiment shown in FIG. 3, for example, the belly 352 defines a bottom of the antenna 304. The opposing sides 354, 356 of the folded antenna 304 form an elongated gap 301 that faces the top of the enclosure 302. The elongated gap 301 serves as the effective radiator of the folded antenna 304. Using an electrical description, the folded antenna 304 can be described as a unique type of electrically small loop antenna, symmetric folded patch antenna, magnetic dipole antenna, or differentially fed planar inverted F antenna or PIFA.

The folded antenna 304 is positioned in close proximity to walls of the enclosure 302 so that the folded antenna 304 encompasses at least part of the spine 310 and at least some of the electronics 306 of the hearing device 300. As shown, the folded antenna 304 encompasses the spine 310, all of the electronics 306, and the battery 308 of the hearing device 300. The components of the enclosure 302 considered encompassed by the folded antenna 304 are those components captured between the opposing sides 354 and 356 of the antenna 304. In an electrical context, components of the enclosure 302 considered encompassed by the folded antenna 304 are those components (e.g., spine 310 and/or electronics 306) that can effectively become part of the matching network that serves to tune the antenna 304. Antenna feed lines 314a and 314b electrically couple opposing sides 354 and 356 of the folded antenna 304 to a radio of the electronics 306.

In some embodiments, the folded antenna 304 constitutes a stamped metal structure with cutouts having a shape and location described hereinbelow. In other embodiments, the folded antenna 304 constitutes a metal plated structure with cutouts having a shape and location described hereinbelow. For example, the antenna 304 can be plated inside and/or outside of the enclosure 302, essentially forming a solid metalized shell. According to other embodiments, the folded antenna 304 can be a discontinuous structure comprising a multiplicity of connected antenna portions. For example, the folded antenna 304 can be split into several parts with tight coupling between each part to make the antenna 304 more manufacturable, for example, using flex printed circuit board technology. For example, the folded antenna 304 can comprise a conductive layer on a flexible printed circuit board. By way of further example, the folded antenna 304 can be a laser direct structuring (LDS) structure. The folded antenna 304 can have dimensions, features, and functionality disclosed in commonly-owned U.S. Patent Publication No. 2018/0138583, which is incorporated herein by reference.

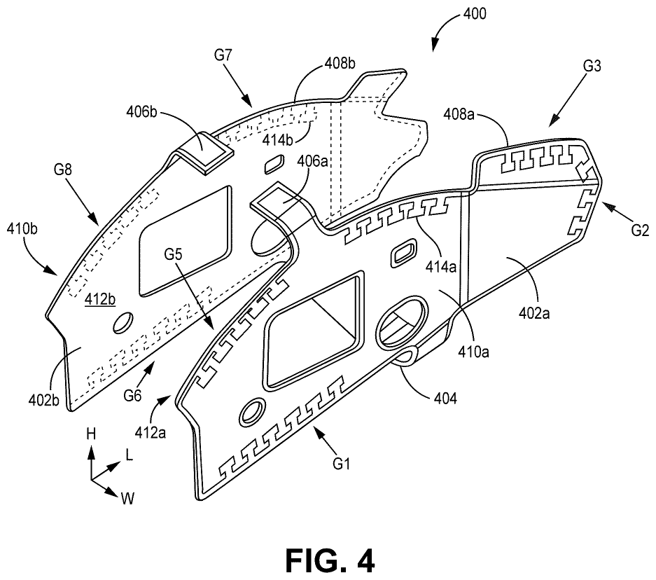

According to some embodiments, the antenna 304 can be implemented as a bowtie-type antenna. Various embodiments of a bowtie antenna 304 incorporating cutouts according to the present disclosure are shown in FIGS. 4-9B. A bowtie antenna can be considered a type of dipole broadband antenna. In general, a bowtie antenna can include two roughly parallel conductive plates that can be fed at a gap between the two conductive plates. Examples of bowtie antennas that may be used in hearing devices of the present disclosure are described in U.S. patent application Ser. No. 14/706,173, entitled “HEARING AID BOWTIE ANTENNA OPTIMIZED FOR EAR TO EAR COMMUNICATIONS,” filed on May 7, 2015, U.S. patent applicant Ser. No. 15/331,077, entitled “HEARING DEVICE WITH BOWTIE ANTENNA OPTIMIZED FOR SPECIFIC BAND,” filed on Oct. 21, 2016, and in U.S. patent application Ser. No. 15/718, 760, entitled “EAR-WORN ELECTRONIC DEVICE INCORPORATING ANTENNA WITH REACTIVELY LOADED NETWORK CIRCUIT,” filed Sep. 28, 2017, which are commonly assigned to Starkey Laboratories, Inc., and incorporated herein by reference in their entirety. It is understood that antennas other than bowtie and folded antennas can be implemented to incorporate peripheral cutouts and/or interior window cutouts in accordance with embodiments of the disclosure. Representative antennas include dipoles, monopoles, dipoles with capacitive-hats, monopoles with capacitive-hats, folded dipoles or monopoles, meandered dipoles or monopoles, loop antennas, Yagi-Uda antennas, log-periodic antennas, inverted-F antennas (IFA), planar inverted-F antennas (PIFA), patch antennas, and spiral antennas.

FIG. 4 is a perspective view of an antenna of a hearing device which incorporates a plurality of cutouts disposed along a periphery of the antenna in accordance with various embodiments. The antenna 400 shown in FIG. 4 has a bowtie configuration and includes two antenna elements 402a, 402b. The two antenna elements 402a, 402b comprise electrically conductive material 410a, 410b oriented substantially in opposition to one another. In the embodiment shown in FIG. 4, the electrically conductive material 410a, 410b (e.g., copper) is disposed on a substrate 412a, 412b. The substrate 412a, 412b can be a flexible substrate (e.g., polyamide) or a rigid substrate (FR-4). When installed within an enclosure of a hearing device, at least some of the electronic circuitry of the hearing device is disposed between the two antenna elements 402a, 402b (see, e.g., FIG. 3). Each of the antenna elements 402a, 402b includes a feed line 406a, 406b, which are electrically coupled to a wireless transceiver disposed within the enclosure of the hearing device.

In some embodiments, the antenna 400 includes at least one electrically conductive strap 404 connected to and between the two antenna elements 402a, 402b. The strap 404 can include a reactive component (e.g., lumped or discrete component) mounted to or mechanically integrated into the strap 404. The reactive component may include a capacitor, an inductor, a chip antenna, or any combination of these components, which can define a reactively loaded network circuit.

Each of the antenna elements 402a, 402b has a periphery 408a, 408b. The antenna elements 402a, 402b include a plurality of cutouts 414a, 414b disposed along the periphery 408a, 408b of the antenna elements 402a, 402b. In the embodiment shown in FIG. 4, each of the cutouts 414a, 414b defines a void in the electrically conductive material 410a, 410b with the substrate 412a, 412b extending across the void. In other embodiments, the cutouts 414a, 414b are provided in both the electrically conductive material 410a, 410b and the substrate 412a, 412b. As shown in FIG. 4, the antenna elements 402a, 402b may include a number of internal windows which are included to accommodate mechanical and/or electrical components situated within the enclosure of the hearing device.

In some embodiments, the cutouts 414a, 414b can be arranged as a plurality of cutout groups each comprising a repeating pattern of cutouts. For example, antenna element 402a is shown to include five groups (G1-G5) of cutouts 414a along the periphery 408a of antenna element 402a. Antenna element 402b is shown to include three groups (G6-G8) of cutouts 414b along the periphery 408b of antenna element 402b. The number of cutouts in each cutout group can vary, such as between about 2 and 10 cutouts. The number of cutouts per cutout group can be the same or different. The number of cutout groups per individual antenna element 402a, 402b can be the same or different. In the embodiment shown in FIG. 4, for example, the number of cutout groups of antenna elements 402a and 402b differ from one another, as do the total number of cutouts included along the periphery 408a, 408b of the two antenna elements 402a, 402b.

The antenna 400 has a physical size, which can be defined by length (L), height (H), and width (W) dimensions. As was discussed previously, the physical size of the antenna 400 is limited by the available space within the enclosure of a particular ear-worn electronic hearing device. A current challenge faced by developers of small sized wireless hearing devices (e.g., a 2.4 GHz wireless device) is the need to reduce the size of the hearing device, which necessitates a reduction in the size of the antenna as well. Reducing the size of the antenna, however, diminishes the overall performance of the antenna. Advantageously, the cutouts 414a, 414b provided along the periphery 408a, 408b of antenna elements 402a, 402b increases the path of the current distribution along the periphery 408a, 408b of the antenna elements 402a, 402b. This increase in the path of the current distribution along the periphery 408a, 408b of the antenna elements 402a, 402b increases the effective electrical length of the antenna 400 without having to increase the physical size (e.g., L, H, and/or W) of the antenna 400.

It can be appreciated that inclusion of a multiplicity of cutouts 414a, 414b along the periphery 408a, 408b of antenna elements 402a, 402b reduces the surface area of the antenna 400 relative to the antenna 400 devoid of the cutouts 414a, 414b. Advantageously, the cutouts 414a, 414b are configured to increase a radiation efficiency of antenna 400 notwithstanding the reduction in antenna surface area due to the presence of the cutouts 414a, 414b. Other improvements in antenna performance can be achieved by inclusion of a multiplicity of cutouts 414a, 414b along the periphery 408a, 408b of antenna elements 402a, 402b. For example, the cutouts 414a, 414b can be configured to provide for an increase in impedance bandwidth of the antenna 400 relative to the antenna 400 devoid of the cutouts 414a, 414b. The cutouts 414a, 414b can be configured to modify one or both of an impedance and a resonance frequency of the antenna 400. The size, shape, number, and location of cutouts and cutout groups can be chosen to achieve one or more of a desired radiation efficiency, impedance bandwidth, impedance, and resonance frequency of the antenna 400.

Although the antenna 400 is shown as including two antenna elements 402a, 402b in the representative embodiment of FIG. 4, it is understood that antenna 400 can include a single antenna element or more than two antenna elements. Also, it is understood that antenna 400 need not have a bowtie configuration, and can be configured according to any of the representative antennas disclosed elsewhere herein.

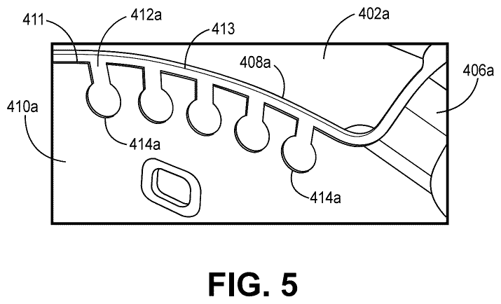

FIG. 5 is a view of a portion of antenna element 402a having a periphery 408a which includes a plurality of cutouts 414a in accordance with various embodiments. In FIG. 5, the cutouts 414a have a shape differing from that of the cutouts 414a shown in FIG. 4. Examples of other cutout shapes are described hereinbelow. FIG. 5 shows that cutouts 414a are provided along a periphery 411 of the electrically conductive material 410a of antenna element 402a. Each of the cutouts 414a defines a void in the electrically conductive material 410a, with the substrate 412a extending across the void. In some embodiments, the periphery 413 of the substrate 412a can be notched, shaped or molded so as to include cutouts that generally conform to the shape of cutouts 414a in the electrically conductive material 410a.

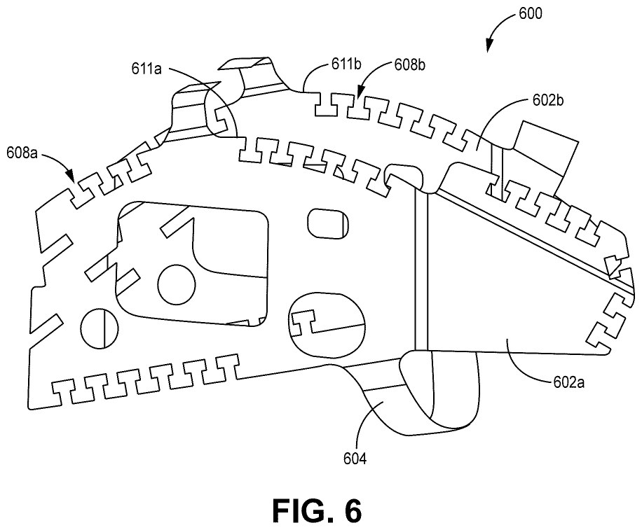

Referring again to FIG. 4, and in accordance with some embodiments, the substrates 412a, 412b can comprise plastic plates that support one or more metallization layers, such as by use of a Laser Direct Structuring (LSD) technique. In other embodiments, the substrates 412a, 412b and electrically conductive material 410A, 410b are components of a flex circuit antenna. According to further embodiments, an antenna having a periphery comprising a plurality of cutouts can comprise one or more stamped metal plates. For example, and with reference to the embodiment shown in FIG. 6, a stamped metal antenna 600 includes two antenna elements 602a, 602b each of which includes a periphery 611a, 611b comprising a plurality of cutouts 608a, 608b. A conductive strap 604 of a type previously described can be connected to and between the two antenna elements 602a, 602b.

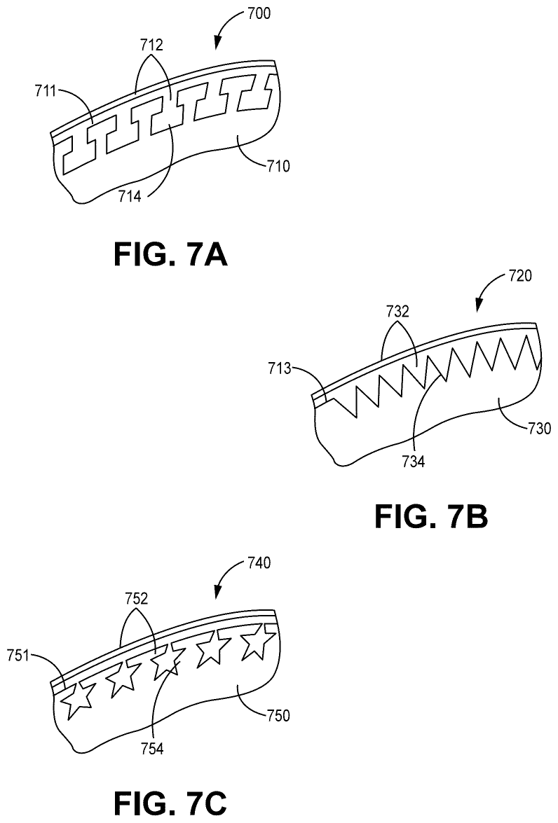

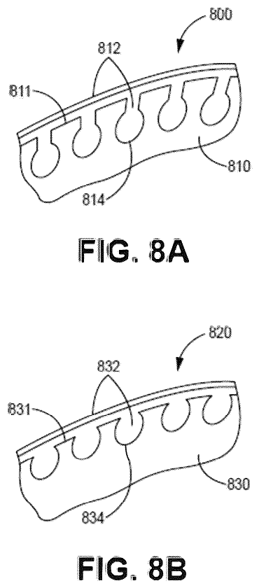

As was previously discussed, the cutouts provided along the periphery of an antenna of an ear-worn electronic hearing device can have a variety of shapes. The cutouts can have a polygonal shape, a generally curved or curvilinear shape, or a combination of polygonal and curved/curvilinear shapes. The cutouts of an antenna can have the same general shape or a combination of different shapes. FIGS. 7A-7C show cutouts having a polygonal shape according to some embodiments. FIGS. 8A and 8B show cutouts having a curved or curvilinear shape according to other embodiments. It is understood that cutouts of an antenna can include a combination of polygonal and curved/curvilinear shapes, such as any combination of shapes shown in FIGS. 7A-7C, 8A, and 8B.

FIG. 7A shows a portion of an antenna 700 which includes electrically conductive material 710 having a periphery 711 according to various embodiments. The periphery 711 includes a plurality of cutouts 714 having a hammer shape. In some embodiments, the electrically conductive material 710 is disposed on a substrate 712 (flexible or rigid), and the cutouts 714 can define voids in the electrically conductive material 710 with the substrate 712 extending across the voids.

FIG. 7B shows a portion of an antenna 720 which includes electrically conductive material 730 having a periphery 731 in accordance with various embodiments. The periphery 731 includes a plurality of cutouts 734 having a sawtooth shape. In some embodiments, the electrically conductive material 730 can be disposed on a substrate 732 (flexible or rigid), and the cutouts 734 can define voids in the electrically conductive material 730 with the substrate 732 extending across the voids.

FIG. 7C shows a portion of an antenna 740 which includes electrically conductive material 750 having a periphery 751 in accordance with various embodiments. The periphery 751 includes a plurality of cutouts 754 having a star shape. In some embodiments, the electrically conductive material 750 can be disposed on a substrate 752 (flexible or rigid), and the cutouts 754 can define voids in the electrically conductive material 750 with the substrate 752 extending across the voids.

FIG. 8A shows a portion of an antenna 800 which includes electrically conductive material 810 having a periphery 811 in accordance with various embodiments. The periphery 811 includes a plurality of cutouts 814 having a lollipop shape. In some embodiments, the electrically conductive material 810 can be disposed on a substrate 812 (flexible or rigid), and the cutouts 814 can define voids in the electrically conductive material 810 with the substrate 812 extending across the voids.

FIG. 8B shows a portion of an antenna 820 which includes electrically conductive material 830 having a periphery 831 in accordance with various embodiments. The periphery 831 includes a plurality of cutouts 834 having a circular shape. In some embodiments, the electrically conductive material 830 can be disposed on a substrate 832 (flexible or rigid), and the cutouts 834 can define voids in the electrically conductive material 830 with the substrate 832 extending across the voids.

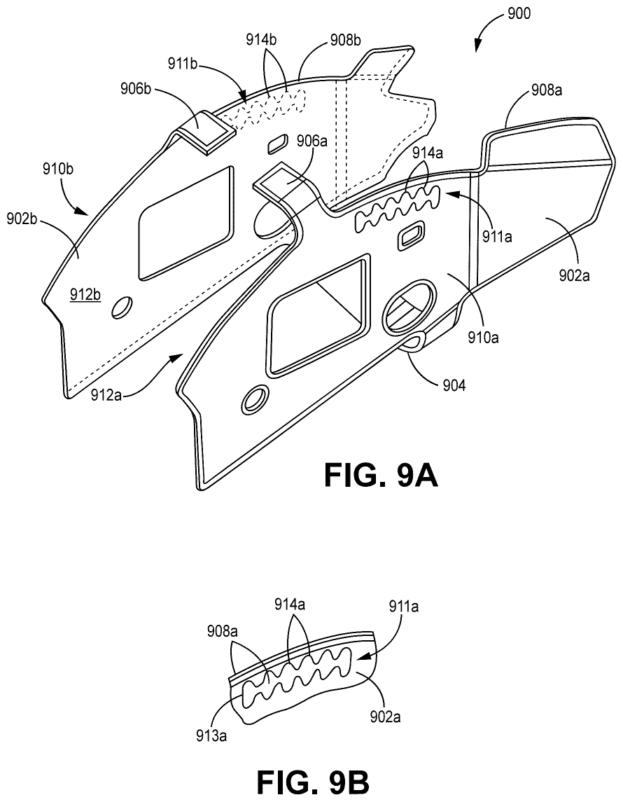

FIG. 9A is a perspective view of an antenna of a hearing device which incorporates one or more interior windows comprising a plurality of window cutouts in accordance with various embodiments. The antenna 900 shown in FIG. 9A has a bowtie configuration and includes two antenna elements 902a, 902b. The two antenna elements 902a, 902b comprise electrically conductive material 910a, 910b oriented substantially in opposition to one another. In the embodiment shown in FIG. 9A, the electrically conductive material 910a, 910b (e.g., copper) is disposed on a substrate 912a, 912b, which can be a flexible substrate (e.g., polyamide) or a rigid substrate (FR-4). When installed within an enclosure of a hearing device, at least some of the electronic circuitry of the hearing device is disposed between the two antenna elements 902a, 902b (see, e.g., FIG. 3). Each of the antenna elements 902a, 902b includes a feed line 906a, 906b, which are electrically coupled to a wireless transceiver disposed within the enclosure of the hearing device. As in the case of the embodiments shown in FIGS. 4 and 6, antenna 900 can include at least one electrically conductive strap 904 of a type previously described connected to and between the two antenna elements 902a, 902b.

The two antenna elements 902a, 902b include at least one interior window 911a, 911b each having a window periphery. A plurality of window cutouts are disposed along the window periphery of interior windows 911a, 911b. FIG. 9B shows additional details of interior window 911a provided in antenna element 902a. Interior window 911a includes a plurality of window cutouts 914a disposed along the window periphery 913a of interior window 911a. In the embodiment of FIG. 9A, interior windows 911a, 911b are positioned near feed lines 906a, 906b and spaced away from the periphery 908a, 908b of antenna elements 902a, 902b. In some embodiments, two, three or more of the interior windows 911a, 911b comprising window cutouts 914a, 914b can be provided within the interior region of the two antenna elements 902a, 902b. The window cutouts 914a, 914b are configured to increase a path length of the current distribution along the window periphery and increase an electrical length of antenna 900 without an increase in the physical size of antenna 900.

In some embodiments, each of the antenna elements 902a, 902b comprises a plurality of cutouts disposed along a periphery 908a, 908b of the antenna elements 902a, 902b as shown in FIGS. 4 and 6 in combination with one or more interior windows 911a, 911b with window cutouts 914a, 914b as shown in FIGS. 9A and 9B.

It is understood that, in other embodiments, antenna 900 can include a single antenna element or more than two antenna elements. Also, it is understood that antenna 900 need not have a bowtie configuration, and can be configured according to any of the representative antennas disclosed elsewhere herein.

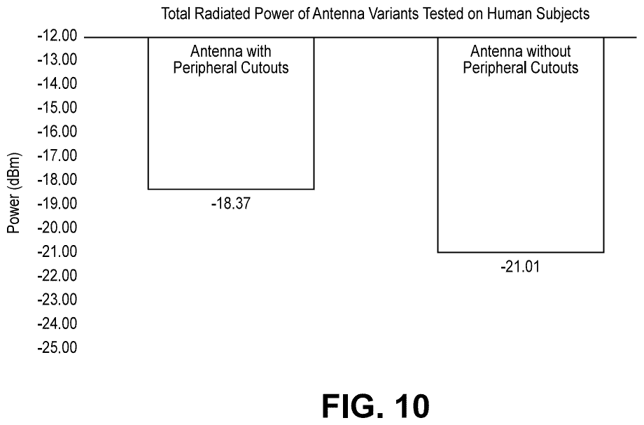

Experiments were performed using hearing devices (e.g., RIC devices) with bowtie antennas having a configuration similar to that of antenna 400 shown in FIG. 4. A hearing device with an antenna comprising peripheral cutouts was placed on the left side of a human wearer's head, and total radiated power (TRP) was measured for this antenna configuration. A hearing device with the antenna devoid of peripheral cutouts was placed on the left side of the human wearer's head, and TRP was measured for this antenna configuration. This testing was repeated for two human subjects. FIG. 10 shows the averaged TRP results comparison of the two antenna variants before factoring out mismatch losses. Both antenna variants were impedance matched between a 100 ohm (nominal) differential output of a SAW (surface acoustic wave) filter and the antenna feed, it being understood that other pre-select filters can be used (e.g., a bulk acoustic wave (BAW) filter). As can be seen in FIG. 10, there is approximately a 2-4 dB improvement in radiation efficiency for the hearing device with the antenna incorporating peripheral cutouts. It is understood that this testing procedure could have been performed on the right side of the wearer's head, and would have resulted in a similar improvement in radiation efficiency for the right hearing device with the antenna incorporating peripheral cutouts.

This document discloses numerous embodiments, including but not limited to the following:

Item 1 is an ear-worn electronic hearing device configured to be worn by a wearer, comprising:
an enclosure configured to be supported by, at, in or on an ear of the wearer;
electronic circuitry disposed in the enclosure and comprising a wireless transceiver; and
an antenna disposed in or on the enclosure and operably coupled to the wireless transceiver, the antenna having a physical size and comprising a plurality of cutouts disposed along a periphery of the antenna, the cutouts configured to increase an electrical length of the antenna without an increase in the physical size of the antenna.

Item 2 is the device of item 1, wherein:
the antenna comprises an antenna element disposed on a substrate comprising electrically insulating material; and
each of the cutouts defines a void in the electrically conductive material with the substrate extending across the void.

Item 3 is the device of item 1, wherein the cutouts are configured to increase a length of a path of current distribution along the periphery of the antenna.

Item 4 is the device of item 1, wherein:
the cutouts reduce a surface area of the antenna relative to the antenna devoid of the cutouts; and
the cutouts are configured to increase a radiation efficiency of the antenna notwithstanding the reduction in antenna surface area.

Item 5 is the device of item 1, wherein the cutouts are configured to increase an impedance bandwidth of the antenna relative to the antenna devoid of the cutouts.

Item 6 is the device of item 1, wherein the cutouts are configured to modify one or both of an impedance and a resonance frequency of the antenna.

Item 7 is the device of item 1, wherein:
the cutouts are arranged as a plurality of cutout groups each comprising a repeating pattern of cutouts; and
two or more of the cutout groups are disposed along different sections of the antenna periphery.

Item 8 is the device of item 1, wherein at least some of the cutouts have a polygonal shape.

Item 9 is the device of item 1, wherein at least some of the cutouts have a generally curved or curvilinear shape.

Item 10 is the device of item 1, wherein at least some of the cutouts have a hammer shape, a star shape, a sawtooth shape, a round shape, an oval shape, an elliptical shape, a lollipop shape, or a combination of any of these shapes.

Item 11 is the device of item 1, wherein the antenna comprises:
at least one interior window having a window periphery; and
a plurality of window cutouts disposed along the window periphery, the window cutouts configured to increase a path length of current distribution along the window periphery.

Item 12 is the device of item 11, wherein at least some of the window cutouts have a polygonal shape, a generally curved or curvilinear shape, or a combination of any of these shapes.

Item 13 is an ear-worn electronic hearing device configured to be worn by a wearer, comprising:
an enclosure configured to be supported by, at, in or on an ear of the wearer;
electronic circuitry disposed in the enclosure and comprising a wireless transceiver; and
an antenna disposed in or on the enclosure and operably coupled to the wireless transceiver, the antenna having a physical size and comprising:
   two antenna elements each comprising electrically conductive material and oriented substantially in opposition to one another, at least some of the electronic circuitry disposed between the two antenna elements;
   at least one strap connected to and between the two antenna elements; and
   a plurality of cutouts disposed along a periphery of the two antenna elements, the cutouts configured to increase an electrical length of the antenna without an increase in the physical size of the antenna.

Item 14 is the device of item 13, wherein:
each of the two antenna elements is disposed on a substrate comprising electrically insulating material; and
each of the cutouts defines a void in the electrically conductive material with the substrate extending across the void.

Item 15 is the device of item 13, wherein the cutouts are configured to increase a length of a path of current distribution along the periphery of the two antenna elements.

Item 16 is the device of item 13, wherein:
the cutouts reduce a surface area of the two antenna elements relative to the two antenna elements devoid of the cutouts; and
the cutouts are configured to increase a radiation efficiency of the antenna notwithstanding the reduction in surface area of the two antenna elements.

Item 17 is the device of item 13, wherein the cutouts are configured to increase an impedance bandwidth of the antenna relative to the antenna devoid of the cutouts.

Item 18 is the device of item 13, wherein the cutouts are configured to modify one or both of an impedance and a resonance frequency of the antenna.

Item 19 is the device of item 13, wherein:
the cutouts are arranged as a plurality of cutout groups each comprising a repeating pattern of cutouts; and
two or more of the cutout groups are disposed along different sections of the periphery of each of the two antenna elements.

Item 20 is the device of item 13, wherein at least some of the cutouts have a polygonal shape.

Item 21 is the device of item 13, wherein at least some of the cutouts have a generally curved or curvilinear shape.

Item 22 is the device of item 13, wherein one or both of the two antenna elements comprises:
at least one interior window having a window periphery; and
a plurality of window cutouts disposed along the window periphery, the window cutouts configured to increase a path length of current distribution along the window periphery.

Item 23 is the device of item 22, wherein at least some of the window cutouts have a polygonal shape, a generally curved or curvilinear shape, or a combination of any of these shapes.

Item 24 is an ear-worn electronic hearing device configured to be worn by a wearer, comprising:
an enclosure configured to be supported by, at, in or on an ear of the wearer;
electronic circuitry disposed in the enclosure and comprising a wireless transceiver; and
an antenna disposed in or on the enclosure and operably coupled to the wireless transceiver, the antenna having a physical size and comprising:
   at least one interior window having a window periphery; and
   a plurality of window cutouts disposed along the window periphery, the window cutouts configured to increase a path length of current distribution along the window periphery and increase an electrical length of the antenna without an increase in the physical size of the antenna.

Item 25 is the device of item 24, wherein:
the antenna comprises two antenna elements each comprising electrically conductive material and oriented substantially in opposition to one another, at least some of the electronic circuitry disposed between the two antenna elements;
at least one strap is connected to and between the two antenna elements; and
each of the two antenna elements comprises at least one of the interior windows.

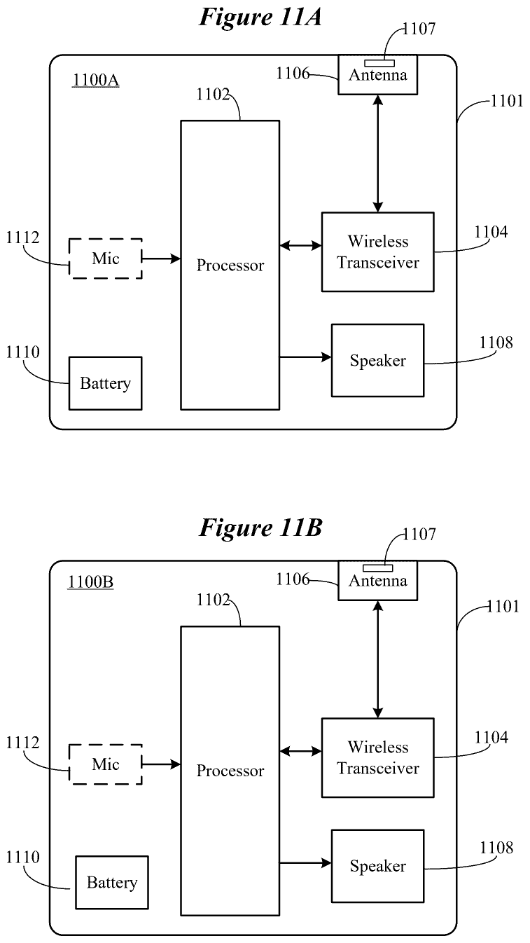

FIGS. 11A and 11B illustrate various components of a representative hearing device arrangement in accordance with various embodiments. FIGS. 11A and 11B illustrate first and second hearing devices 1100A and 1100B configured to be supported at, in or on left and right ears of a wearer. In some embodiments, a single hearing device 1100A or 1100B can be supported at, in or on the left or right ear of a wearer. As illustrated, the first and second hearing devices 1100A and 1100B include the same functional components. It is understood that the first and second hearing devices 1100A and 1100B can include different functional components.

The first and second hearing devices 1100A and 1100B include an enclosure 1101 configured for placement, for example, over or on the ear, in the external ear canal or behind the ear. Disposed within the enclosure 1101 is a processor 1102 which incorporates or is coupled to memory. The processor 1102 can include or be implemented as a multi-core processor, a digital signal processor (DSP), an audio processor or a combination of these processors. For example, the processor 1102 may be implemented in a variety of different ways, such as with a mixture of discrete analog and digital components that include a processor configured to execute programmed instructions contained in a processor-readable storage medium (e.g., solid-state memory).

The processor 1102 is coupled to a wireless transceiver 1104 (also referred to herein as a radio), such as a BLE transceiver. The wireless transceiver 1104 is coupled to an antenna 1106 configured for transmitting and receiving radio signals. The antenna 1106, according to various embodiments, incorporates one or more slot radiating elements 1107. The wireless transceiver 1104 and antenna 1106 can be configured to enable ear-to-ear communication between the two hearing devices 1100A and 1100B, as well as communications with an external device. A battery 1110 or other power source (rechargeable or conventional) is provided within the enclosure 1101 and is configured to provide power to the various components of the hearing devices 1100A and 1100B. A speaker or receiver 1108 is coupled to an amplifier (not shown) and the processor 1102. The speaker or receiver 1108 is configured to generate sound which is communicated to the wearer's ear.

In some embodiments, the hearing devices 1100A and 1100B include a microphone 1112 mounted on the enclosure 1101. The microphone 1112 may be a single microphone or multiple microphones, such as a microphone array. The microphone 1112 can be coupled to a preamplifier (not shown), the output of which is coupled to the processor 1102. The microphone 1112 receives sound waves from the environment and converts the sound into an input signal. The input signal is amplified by the preamplifier and sampled and digitized by an analog-to-digital converter of the processor 1102, resulting in a digitized input signal. In some embodiments (e.g., hearing aids), the processor 1102 (e.g., DSP circuitry) is configured to process the digitized input signal into an output signal in a manner that compensates for the wearer's hearing deficiency. When receiving an audio signal from an external source, the wireless transceiver 1104 may produce a second input signal for the DSP circuitry of the processor 1102 that may be combined with the input signal produced by the microphone 1112 or used in place thereof. In other embodiments, (e.g., hearables), the processor 1102 can be configured to process the digitized input signal into an output signal in a manner that is tailored or optimized for the wearer (e.g., based on wearer preferences). The output signal is then passed to an audio output stage that drives the speaker or receiver 1108, which converts the output signal into an audio output.

As was discussed previously, the antenna 1106 includes one or more slot radiating elements 1107 in the form of one or more cutouts of the antenna 1106. Generally, inclusion of one or more cutouts in an antenna reduces the aperture of the antenna and, hence, the radiation efficiency of the antenna. As such, one of ordinary skill in the art would not be inclined to incorporate cutouts in an antenna for a hearing device, since doing so would reduce the radiation efficiency of the antenna. In the construction of many hearing devices, it is often necessary to create one or more cutouts in the antenna in order to meet the mechanical requirements of the hearing device. For example, one or more cutouts in the antenna of the hearing device may be needed in order to accommodate various mechanical, electrical, and/or optical structures or components of the hearing device. In general, such cutouts in the antenna reduce the radiation efficiency of the antenna of the hearing device.

It has been discovered by the inventor that incorporating one or more cutouts that define slot radiating elements 1107 in the antenna 1106 advantageously increases the radiation efficiency of the antenna 1106. The antenna 1106 incorporates one or more slot radiating elements 1107 that provide for improved wireless performance of the first and second hearing devices 1100A and 1100B. In various embodiments, each slot radiating element 1107 constitutes a cutout in the antenna 1106 which is designed so that normal excitation of the antenna 1106 also excites slot modes of the cutout. The cutout is configured to radiate with the antenna 1106 to contribute to an electric field generated by the antenna 1106. For example, the antenna 1106 is configured such that currents flowing through the antenna 1106 excite both the antenna 1106 and slot modes of the cutout. In other words, the cutout operates as a slot mode antenna incorporated in another antenna 1106.

In some embodiments, the antenna 1106 includes one or more cutouts specifically designed to serve as slot radiating elements 1107. In other embodiments, the antenna 1106 includes one or more cutouts designed to meet the mechanical requirements of the hearing device, and these cutouts are designed to serve as slot rating elements 1107. In such embodiments, the cutouts that are incorporated in the antenna 1106 to meet mechanical requirements are designed so that normal excitation of the antenna 1106 also excites slot modes of these cutouts. Notwithstanding the reduction in the effective aperture of the antenna 1106 by inclusion of one or more slot radiating elements 1107, excitation of the slot radiating elements 1107 in addition to the antenna 1106 results in an improved radiation efficiency of the antenna 1106.

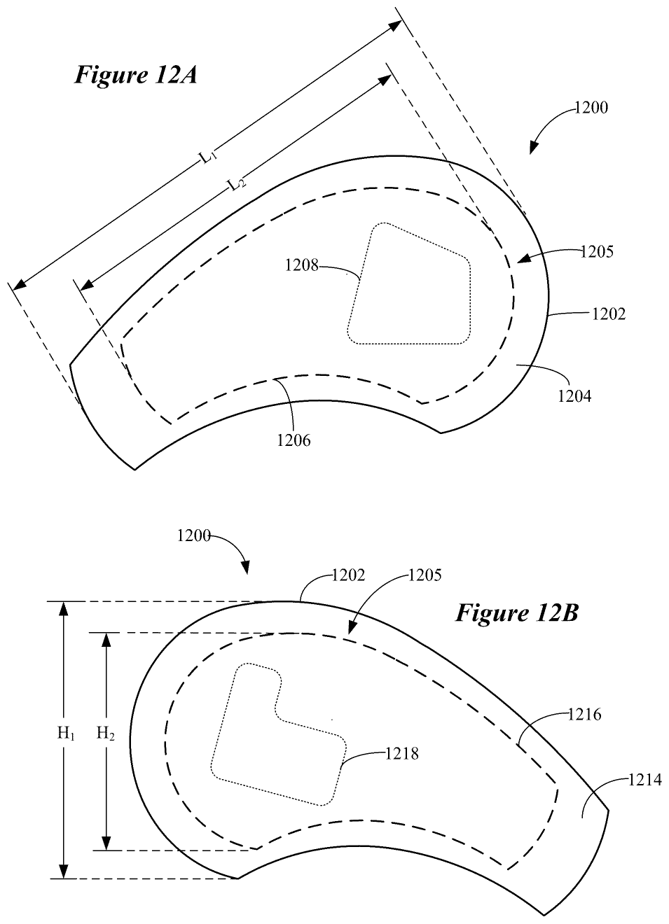

FIGS. 12A and 12B illustrate a hearing device which incorporates an antenna comprising one or more slot radiating elements in accordance with various embodiments. The hearing device 1200 shown in FIGS. 12A and 12B is representative of a BTE or RIC hearing device (e.g., hearing aid), but can alternatively be representative of any hearing device configuration. The hearing device 1200 includes an enclosure 1202 having a first side 1204 (shown in FIG. 12A) and a second side 1214 (shown in FIG. 12B). The hearing device 1200 includes an antenna 1205 comprising a first antenna element 1206 supported by or positioned proximate to the first side 1204 and a second antenna element 1216 supported by or positioned proximate to the second side 1214 of the enclosure 1202. In some embodiments, a strap is connected to, and between, the first and second antenna elements 1206, 1216. In such embodiments, the strap can incorporate at least one slot radiating element.

In some embodiments, the antenna 1205 is a folded structure, such that a gap is formed between the two roughly parallel first and second antenna elements 1206, 1216. The first and second antenna elements 1206, 1216 can constitute solid sections (e.g., stamped metal plates) that are attached to or supported by the first and second sides 1204, 1214 of the enclosure 1202. In other embodiments, the first and second antenna elements 1206, 1216 can include plastic plates that support a metallization layer(s), such as by use of a Laser Direct Structures (LDS) technique. In further embodiments, the first and second antenna elements 1206, 1216 can be implemented as flex circuits within the enclosure 1202 (e.g., outer shell) of the hearing device 1200.

Each of the first and second antenna elements 1206, 1216 comprises electrically conductive material and has an area greater than an area of a feedline that couples the antenna 1205 to the wireless transceiver disposed within the enclosure 1202. Suitable electrically conductive materials include copper, silver, gold, aluminum, tin, nickel, and alloys and/or combinations of these metals. The first and second antenna elements 1206, 1216 are oriented substantially in opposition to one another and at least some of the electronic circuitry within the enclosure 1202 is disposed between the first and second antenna elements 1206, 1216. For example, one or more of the components shown in FIGS. 11A and 11B are disposed between the first and second antenna elements 1206, 1216.

As is shown in FIGS. 12A and 12B, the enclosure 1202 has a length, L₁, and a height, H₁. The antenna 1205 (e.g., the first and second antenna elements 1206, 1216) has a length, L₂, and a height H₂. In some embodiments, the antenna 1205 has a length, L₂, that is at least about 50% of the length, L₁, of the enclosure 1202. For example, the length, L₂ can be at least about 50%, 60%, 70%, 80% or 90% of the length, L₁. In some embodiments, the antenna 1205 has a height, H₂, that is at least about 50% of the height, H₁, of the enclosure 1202. For example, the height, H₂, can be at least about 50%, 60%, 70%, 80% or 90% of the height, H₁. In other embodiments, the antenna 1205 can have a length, L₂ that is less than 50% (e.g., 40%, 30%) of the length, L₁ of the enclosure 1202. In such embodiments or further embodiments, the antenna 1205 can have a height, H₂ that is less than 50% (e.g., 40%, 30%) of the height, H₁ of the enclosure 1202. It is understood that first and second antenna elements 1206, 1216 can have different lengths and/or heights (e.g., different shapes).

The first and second antenna elements 1206, 1216 can incorporate one or more slot radiating elements 1208, 1218 having the same shape or different shapes. It is noted that, in some embodiments, only one of the first and second antenna elements 1206, 1216 includes one or more slot radiating elements. For example, the first antenna element 1206 (positionable adjacent the wearer's head) may be devoid of a slot radiating element, while the second antenna element 1218 (positioned away from the wearer's head) may incorporate one or more slot radiating elements. The first antenna element 1206 shown in FIG. 12A includes a slot radiating element 1208 having a generally trapezoidal shape. The second antenna element 1216 shown in FIG. 12B includes a slot radiating element 1218 having a generally “L” or step shape (e.g., a combined rectangular and square shape). As will be discussed hereinbelow, the slot radiating elements 1208, 1218 can have a wide variety of shapes.

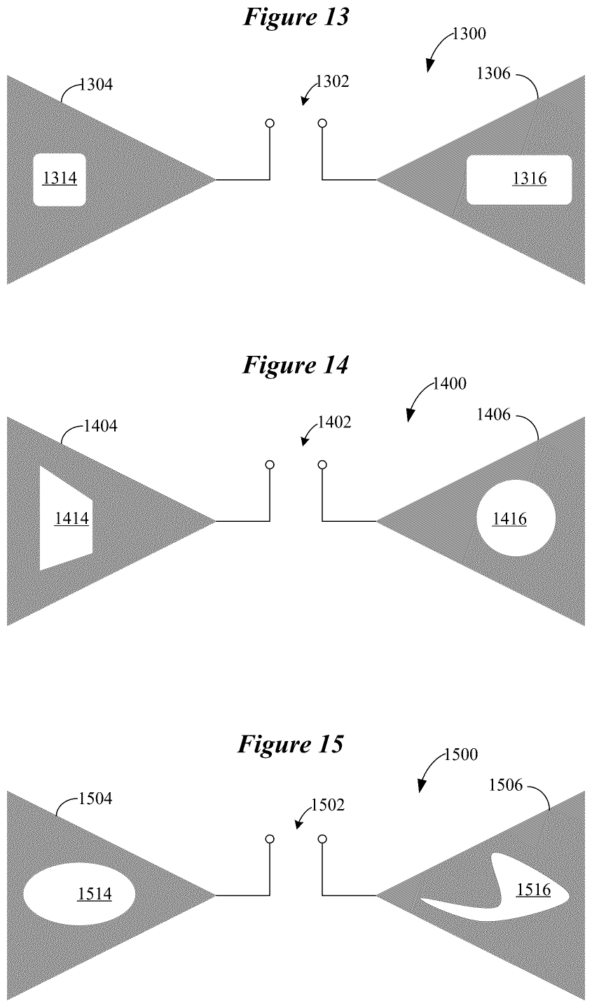

FIG. 13 illustrates an antenna 1300 which includes one or more slot radiating elements in accordance with various embodiments. The antenna 1300 shown in FIG. 13 (and other figures) is a bowtie-type antenna, referred to herein generally as a bowtie antenna. A bowtie antenna can be considered a type of dipole broadband antenna. In general, a bowtie antenna can include two roughly parallel conductive plates that can be fed at a gap between the two conductive plates. Examples of bowtie antennas that may be used in hearing devices are described in U.S. patent application Ser. No. 14/706,173, entitled “HEARING AID BOWTIE ANTENNA OPTIMIZED FOR EAR TO EAR COMMUNICATIONS,” filed on May 7, 2015, U.S. patent applicant Ser. No. 15/331,077, entitled “HEARING DEVICE WITH BOWTIE ANTENNA OPTIMIZED FOR SPECIFIC BAND,” filed on Oct. 21, 2016, and in U.S. patent application Ser. No. 15/718,760, entitled “EAR-WORN ELECTRONIC DEVICE INCORPORATING ANTENNA WITH REACTIVELY LOADED NETWORK CIRCUIT,” filed Sep. 28, 2017, which are commonly assigned to Starkey Laboratories, Inc., and incorporated herein by reference in their entirety. It is understood that antennas other than bowtie antennas can be implemented to include one or more slot radiating elements in accordance with embodiments of the disclosure. Representative antennas include dipoles, monopoles, dipoles with capacitive-hats, monopoles with capacitive-hats, folded dipoles or monopoles, meandered dipoles or monopoles, loop antennas, Yagi-Uda antennas, log-periodic antennas, inverted-F antennas (IFA), planar inverted-F antennas (PIFA), patch antennas, and spiral antennas.

The antenna 1300 shown in FIG. 13 is a bowtie-type antenna which includes substantially solid first and second antenna elements 1304, 1306 and a feedline 1302. The first and second antenna elements 1304, 1306 are formed from electrically conductive material and have an area greater than an area of the feedline 1302. At least one of the first and second antenna elements 1304, 1306 includes one or more slot radiating elements. As illustrated, the first antenna element 1304 includes a slot radiating element 1314 having a substantially square shape, and the second antenna element 1306 includes a slot radiating element 1316 having a substantially rectangular shape.

FIG. 14 illustrates an antenna 1400 which includes one or more slot radiating elements in accordance with various embodiments. The antenna 1400 shown in FIG. 14 is a bowtie-type antenna which includes substantially solid first and second antenna elements 1404, 1406 and a feedline 1402. The first and second antenna elements 1404, 1406 are formed from electrically conductive material and have an area greater than an area of the feedline 1402. At least one of the first and second antenna elements 1404, 1406 includes one or more slot radiating elements. As illustrated, the first antenna element 1404 includes a slot radiating element 1414 having a substantially trapezoidal shape, and the second antenna element 1406 includes a slot radiating element 1416 having a substantially circular shape.

FIG. 15 illustrates an antenna 1500 which includes one or more slot radiating elements in accordance with various embodiments. The antenna 1500 shown in FIG. 15 is a bowtie-type antenna which includes substantially solid first and second antenna elements 1504, 1506 and a feedline 1502. The first and second antenna elements 1504, 1506 are formed from electrically conductive material and have an area greater than an area of the feedline 1502. At least one of the first and second antenna elements 1504, 1506 includes one or more slot radiating elements. As illustrated, the first antenna element 1504 includes a slot radiating element 1514 having a substantially oval shape, and the second antenna element 1506 includes a slot radiating element 1516 having an arbitrary shape (e.g., arbitrary closed curve).

In FIGS. 13-15 and other figures, the slot radiating elements incorporated in the antenna have a variety of shapes that are shown for purposes of illustration, and not of limitation. It is understood that the slot radiating elements can have a wide variety of shapes. For example, a slot radiating element can comprise an N-sided polygon, where N>=3. A slot radiating element can have a regular or irregular polygonal shape, such as the shape of a regular or irregular square, rectangle, triangle, quadrilateral, trapezoid, rhombus, parallelogram, kite, pentagon, hexagon, heptagon, octagon, nonagon, decagon or dodecagon, or a combination of any of these shapes. A slot radiating element can have a curved or curvilinear shape, such as a circle, oval, ellipse, crescent, quatrefoil, curvilinear polygon, an arbitrary closed curve, or a combination of any of these shapes. A slot radiating element can have a combination of polygonal and curvilinear shapes.

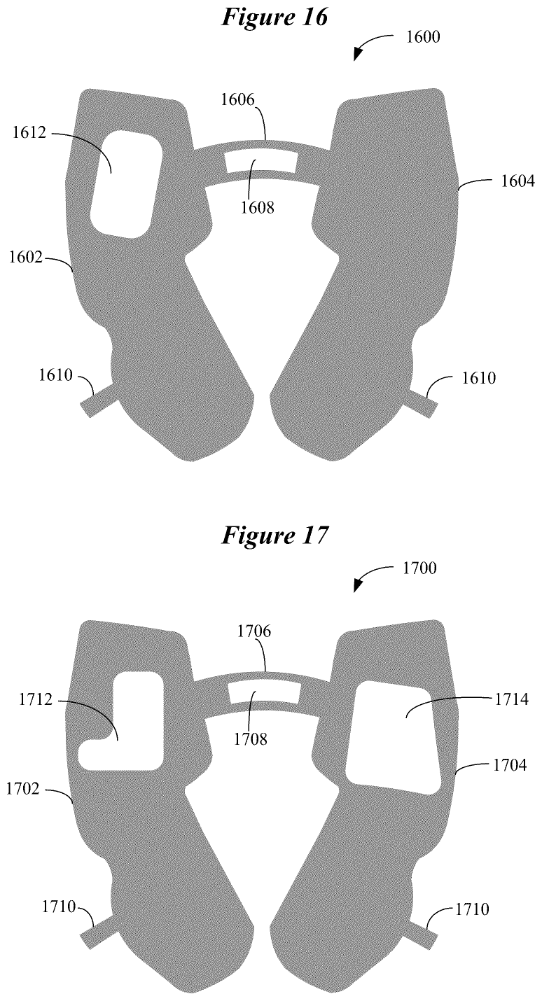

FIG. 16 illustrates an antenna 1600 which includes one or more slot radiating elements in accordance with various embodiments. The antenna 1600 shown in FIG. 16 is a bowtie antenna shown in a flattened state for illustrative purposes. The antenna 1600 includes a first antenna element 1602, a second antenna element 1604, and an electrically conductive strap 1606 connected to, and between, the first and second antenna element 1602, 1604. When installed in a hearing device enclosure, the antenna 1600 assumes a folded shape, such that the first antenna element 1602 is oriented substantially in opposition to, and roughly parallel with, the second antenna element 1604. A feedline 1610 is coupled to the first and second antenna elements 1602, 1604 and a radio of the hearing device.

Although not shown in FIG. 16 and other figures, it is understood that, in some embodiments, that radio of the hearing device and the feedline 1610 can be coupled via an intervening matching network or a filter. Is it also understood that, in some embodiments, the feedline 1610 can be a “connectionless” or “non-contacting” feed, such that antenna 1600 is physically separated from the feedline 1610 by a dielectric material. The dielectric material enables the feedline 1610 to remain electrically coupled to the antenna 1600, such that energy on the feedline 1610 can be transferred to the antenna 1600 and energy received at the antenna 1600 can be transferred to the feedline 1610. Examples of non-contacting feed and antenna coupling arrangements are described in U.S. Published Patent Application No. 2016/0295335, entitled “NON-CONTACT ANTENNA FEED,” which is commonly assigned to Starkey Laboratories, Inc., and incorporated herein by reference in its entirety.

In accordance with some embodiments, at least one of the first and second antenna elements 1602, 1604 includes one or more slot radiating elements. In the embodiment shown in FIG. 16, only one of the first and second antenna elements 1602, 1604 includes one or more slot radiating elements. More particularly, the first antenna element 1602 is shown to include a single slot radiating element 1612. It is understood that in some embodiments, a single antenna element (e.g., the first antenna element 1602) can incorporate two or more slot radiating elements. As shown, the slot radiating element 1612 has a generally rectangular shape, but may be of any shape as described herein. In some embodiments, the strap 606 may include one or more slot radiating elements. As shown, the strap 1606 includes a single slot radiating element 1608. The slot radiating element 1608 incorporated in the strap 1606 is shown to have a generally curvilinear rectangular shape, but can be of any shape as described herein.

FIG. 17 illustrates an antenna 1700 which includes one or more slot radiating elements in accordance with various embodiments. The antenna 1700 shown in FIG. 17 is configured as a bowtie antenna shown in a flattened state for illustrative purposes. The antenna 1700 includes a first antenna element 1702, a second antenna element 1704, and a strap 1706 connected to, and between, the first and second antenna elements 1702, 1704. When installed in a hearing device enclosure, the antenna 1700 assumes a folded shape, such that the first antenna element 1702 is oriented substantially in opposition to, and roughly parallel with, the second antenna element 1704. A feedline 1710 is coupled to the first and second antenna elements 1702, 1704 and a radio of the hearing device.

In the embodiment shown in FIG. 17, each of the first and second antenna elements 1702, 1704 includes one or more slot radiating elements. More particularly, the first antenna element 1702 includes a single slot radiating element 1712, and the second antenna element 1704 includes a single slot radiating element 1714. It is understood that in some embodiments, one of the first and second antenna element 1702, 1704 can include a single slot radiating element, while the other of the first and second antenna elements 1702, 1704 can include a multiplicity of slot radiating elements. As shown, the slot radiating element 1712 has a generally “L” or step shape, and the slot radiating element 1714 has a generally trapezoidal shape. It is understood that slot radiating elements 1712, 1714 may be of any shape as described herein. In some embodiments, the strap 1706 may include one or more slot radiating elements. As shown, the strap 1706 includes a single slot radiating element 1708. The slot radiating element 1708 incorporated in the strap 1706 is shown to have a generally curvilinear rectangular shape, but can be of any shape as described herein.

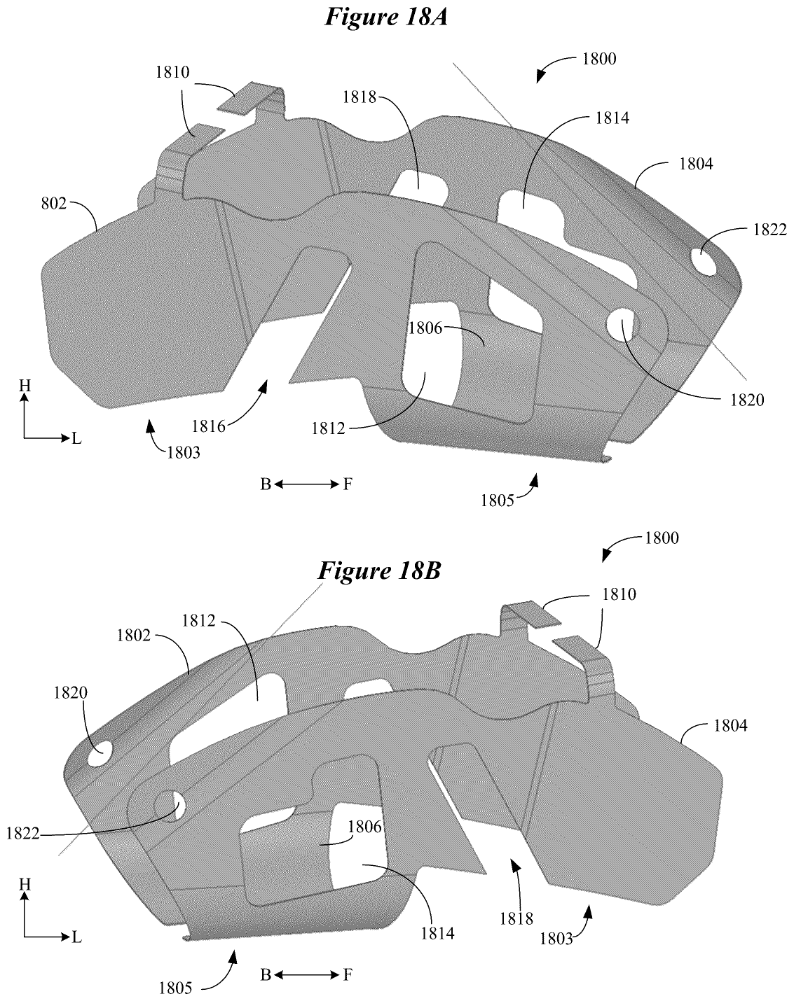

FIGS. 18A and 18B illustrate an antenna 1800 which includes slot radiating elements in accordance with various embodiments. The antenna 1800 is configured as a bowtie antenna and is illustrated in a folded state, which is the state the antenna 1800 assumes when installed in a hearing device enclosure. The antenna 1800 is well suited for incorporation in an RIC or BTE hearing aid, for example. The antenna 1800 includes a first antenna element 1802, a second antenna element 1804, and a strap 1806 connected to, and between, the first and second antenna elements 1802, 1804. FIG. 18A shows the first antenna element 1802 in the foreground, and the second antenna element 1804 in the background. FIG. 18B shows the antenna 1800 rotated 180 degrees from the orientation shown in FIG. 18A. As shown, the first antenna element 1802 is oriented substantially in opposition to, and roughly parallel with, the second antenna element 1804. A feedline 1810 is coupled to the first and second antenna elements 1802, 1804 and a radio of the hearing device.

The antenna 1800 has a back region 1803 and a forward region 1805. In the back region 1803, the first and second antenna elements 1802, 1804 are substantially solid, and are devoid of slot radiating elements. In the forward region 1805, the first and second antenna elements 1802, 1804 are substantially solid and include slot radiating elements 1812 and 1814, respectively. Simulation of the antenna 1800 revealed that the electric field is strongest in the back region 1803 and inside the slot radiating elements 1812, 1814 of the antenna 1800. The electric field data and the current pattern across the antenna 1800 indicates that the back region 1803 acts as a bowtie, while the forward region 805 has a slot mode being excited. It is noted that, in the embodiment shown in FIGS. 18A and 18B, the first and second antenna elements 1802, 1804 include channel cutouts 1816 and 1818 and circular cutouts 1820 and 1822, respectively. The channel cutouts 1816, 1818 and circular cutouts 1820, 1822 are provided to meet mechanical requirements of the antenna 1800 when installed in the housing of the hearing device.

As illustrated, slot radiating element 1812 has a generally trapezoidal shape, and slot radiating element 1814 has a generally “L” or step shape. According to some embodiments, the antenna 1800 has a length, L, of approximately 0.61 inches, and a height, H, of about 0.28 inches. The first and second antenna elements 1802, 1804 are separated by a gap of about 0.2 inches in the region near the slot radiating elements 1812, 1814. The slot radiating element 1812 has a length of about 0.142 inches, a height of about 0.169 inches at the back (B), and a height of about 0.131 inches at the front (F). The slot radiating element 814 has a length, L, of about 0.162 inches at the bottom and about 0.05 inches at the top. The slot radiating element 1814 has a height, H, of about 0.144 inches at the back (B), and about 0.103 inches at the front (F). It is understood that the dimensions of antenna 1800 listed above are provided for non-limiting illustrative purposes.

Several simulations were performed on the antenna 1800 having designed cutouts (slot radiating elements 1812, 1814), as well as on the antenna 1800 having other cutout configurations and no cutouts. The radiation efficiency and impedance were measured for each of the antenna configurations. Results of the simulation are shown in Table 1 below. It was found that the antenna 1800 with the designed cutouts 1812, 1814 had an additional 1.2 dB of radiation efficiency as compared to the antenna 1800 lacking the designed cutouts 1812, 1814. For a hearing device, the additional 1.2 dB of radiation efficiency provided by the slot radiating elements 1812, 1814 represents a significant increase in radiation efficiency of the antenna 1800.

TABLE 1

| | | Radiation | |
|---|---|---|---|
| Antenna | | Efficiency (dB) | Impedance (Ω) |
| (1) | No cutouts, capacitive | −10.14 | 15.28 + j247.39 |
| | component | | |
| (2) | Designed cutouts, capacitive | −8.97 | 12.08 + j156.2 |
| | component | | |
| (3) | Long cutout, capacitive | −9.18 | 12.85 + j170.17 |
| | component | | |
| (4) | Square cutout, capacitive | −9.3 | 14.31 + j195.09 |
| | component | | |
| (5) | No cutouts, inductive strap | −9.79 | 5.25 + j232.68 |
| (6) | Designed cutouts, inductive | −9.89 | 618.27 + j1106.28 |
| | strap | | |
| (7) | Long cutout, inductive strap | −10.4 | 7.62 + j81.96 |
| (8) | Square cutout, inductive strap | −11.17 | 10.53 + j0.39 |

In Table 1 above, antennas (1)-(4) included a capacitive strap 1806 connected to, and between, the first and second antenna elements 1802, 1804. In the simulation of antennas (1)-(4), the strap 1806 included a lumped capacitive component. Antennas (5)-(8) included an inductive strap 1806 connected to, and between, the first and second antenna elements 1802, 1804. In the simulation of antennas (5)-(8), the strap 1806 had a meandering shape that functioned as an inductor. All values in Table 1 above were obtained for the right side of the head and at a driving frequency of 2.44 GHz.

The data in Table 1 above demonstrates that antennas (2)-(4) had an improved radiation efficiency due to excitation of the slot radiating elements 1812, 1814 (relative to antenna (1) with no cutouts) while keeping a similar impedance. The large variation in impedance for antennas (5)-(8) indicates that the cutouts 1812, 1814 did not operate as slot radiating elements in these antenna configurations. It is noted that care should be taken to ensure that the impedance seen at the feedpoint 1810 is similar once the cutouts 1802, 1804 are created in the antenna 1800. Failure to do so can reduce the overall performance of the antenna 1802 due to mismatch losses.

FIG. 9A illustrates an antenna 1900 which includes slot radiating elements in accordance with various embodiments. The antenna 1900 is configured as a bowtie antenna and is illustrated in a folded state, which is the state the antenna 1900 assumes when installed in a hearing device enclosure. The antenna 1900 is well suited for incorporation in an RIC or BTE hearing aid, for example. The antenna 1900 includes a first antenna element 1902, a second antenna element 1904, and a strap 1906 connected to, and between, the first and second antenna elements 1902, 1904. As shown, the first antenna element 1902 is oriented substantially in opposition to, and roughly parallel with, the second antenna element 1904. A feedline 1910 is coupled to the first and second antenna elements 1902, 1904 and a radio of the hearing device.

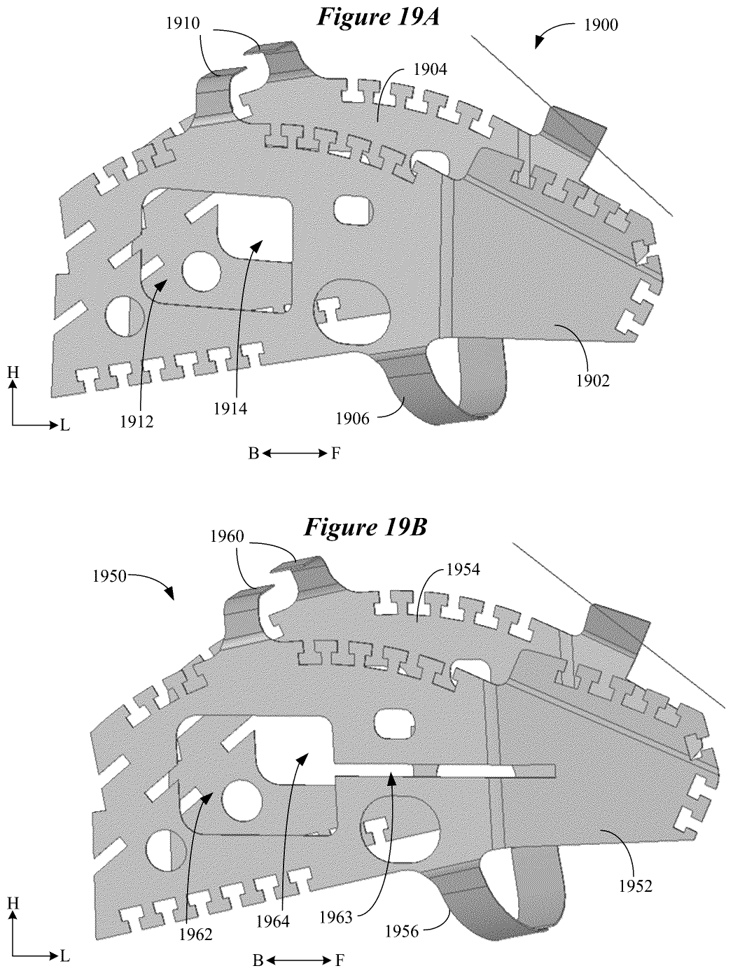

The antenna 1900 shown in FIG. 19A includes slot radiating elements 1912 and 1914 respectively incorporated in the first and second antenna elements 1902, 1904. In the embodiment shown in FIG. 19A, the slot radiating elements 1912, 1914 are identical in size and shape, and are located in close proximity to the feedpoint 1910. The location of the slot radiating elements 1912, 1914 of antenna 1900 differs from that of the slot radiating elements 1812, 1814 of antenna 1800 shown in FIGS. 18A and 18B. The slot radiating elements 1812, 1814 of antenna 1800 are located distant from the feedpoint 1810 (in the forward region 1805), whereas in antenna 1900, the slot radiating elements 1912, 1914 are located in close proximity to the feedpoint 1910 (in the back region under the feedpoint 1910).

FIG. 19B illustrates an antenna 1950 which includes slot radiating elements in accordance with various embodiments. The antenna 1950 has substantially the same construction as antenna 1900 shown in FIG. 19A, but differs in terms of the slot radiating elements. The antenna 1950 includes a first antenna element 1952, a second antenna element 1954, and a strap 1956 connected to, and between, the first and second antenna elements 1952, 1954. As shown, the first antenna element 1952 is oriented substantially in opposition to, and roughly parallel with, the second antenna element 1954. A feedline 1960 is coupled to the first and second antenna elements 1952, 1954 and a radio of the hearing device. The antenna 1950 includes slot radiating elements 1962 and 1964 respectively incorporated in the first and second antenna elements 1952, 1954. In the embodiment shown in FIG. 19B, the slot radiating elements 1962, 1964 are identical in size and shape, and are located in close proximity to the feedpoint 1960.

With reference to FIGS. 19A and 19B, and in accordance with some embodiments, antennas 1900, 1950 have a length, L, of approximately 0.6 inches and a height, H, of about 0.3 inches. The first and second antenna elements 1902, 1952 and 1904, 1954 are spaced apart from one another by a gap of about 0.2 inches. The slot radiating elements 1912, 1914, 1962, 1964 are substantially rectangular in shape and have a length, L, of about 0.135 inches and a height, H, of about 0.1 inches. As is shown in FIG. 19B, each of the slot radiating elements 1962, 1964 includes an auxiliary slot 1963 (not seen in second antenna element 1954) which provides additional radiation efficiency. The auxiliary slot 1963 has a length, L, of about 0.1159 inches and a height, H, of about 0.0119 inches.

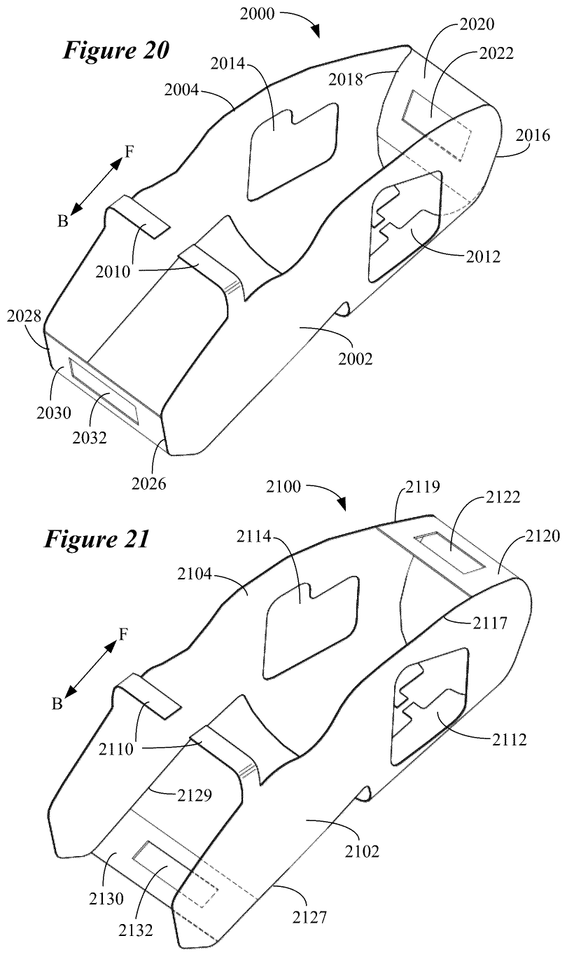

FIG. 20 illustrates an antenna 2000 which includes slot radiating elements in accordance with various embodiments. The antenna 2000 includes a first antenna element 2002 comprising a slot radiating element 2012, and a second antenna element 2004 comprising a slot radiating element 2014. The first antenna element 2002 is oriented substantially in opposition to, and roughly parallel with, the second antenna element 2004. A feedpoint 2010 is coupled to the first and second antenna elements 2002, 2004 and a radio of the hearing device. The antenna 2000 includes a front strap 2020 which includes a slot radiating element 2022. The front strap 2020 is connected to, and extends between, respective front surfaces 2016, 2018 of the first and second antenna elements 2002, 2004.

The antenna 2000 also includes a back strap 2030 which includes a slot radiating element 2032. The back strap 2030 is connected to, and extends between, respective back surfaces 2026, 2028 of the first and second antenna elements 2002, 2004. Inclusion of the front and back straps 2020, 2030 comprising slot radiating elements 2022, 2032 modifies the polarization of the radiated signal for improving ear-to-ear communication between a pair of hearing devices that incorporate the antenna 2000. It is understood that slot radiating elements 2012, 2014, 2022, 2032 may be of any shape as described herein.

FIG. 21 illustrates an antenna 2100 which includes slot radiating elements in accordance with various embodiments. The antenna 2100 includes a first antenna element 2102 comprising a slot radiating element 2112, and a second antenna element 2104 comprising a slot radiating element 2114. The first antenna element 2102 is oriented substantially in opposition to, and roughly parallel with, the second antenna element 2104. A feedpoint 2110 is coupled to the first and second antenna elements 2102, 2104 and a radio of the hearing device. The antenna 2100 includes a top strap 2120 which includes a slot radiating element 2122. The top strap 2120 is connected to, and extends between, respective top surfaces 2117, 2119 of the first and second antenna elements 2102, 2104. The top strap 2120 is shown positioned at the distal front end of the antenna 2100. In some embodiments, the top strap 2120 can be positioned away from the distal front end of the antenna 2100.

The antenna 2100 also includes a bottom strap 2130 which includes a slot radiating element 2132. The bottom strap 2130 is connected to, and extends between, respective bottom surfaces 2127, 2129 of the first and second antenna elements 2102, 2104. The bottom strap 2130 is shown positioned at the distal back and of the antenna 2100. In some embodiments, the bottom strap 2130 can be positioned away from the distal back end of the antenna 2100. Inclusion of the top and bottom straps 2120, 2130 comprising slot radiating elements 2122, 2132 modifies the polarization of the radiated signal for improving ear-to-ear communication between a pair of hearing devices that incorporate the antenna 2100. It is understood that slot radiating elements 2112, 2114, 2122, 2132 may be of any shape as described herein.

According to some embodiments, an antenna can include one or a combination of any of the straps 2020, 2030, 2120, 2130 shown in FIGS. 20 and 21. For example, the antenna 2000 shown in FIG. 20 can exclude the front strap 2022 or the back strap 2030. The antenna 2100 shown in FIG. 21 can exclude the top strap 2120 or the bottom strap 2130. Moreover, an antenna can include selected straps from the embodiment shown in FIGS. 20 and 21. For example, an antenna can include one or both of the front and back straps 2020, 2030 in combination with one or both of the top and bottom straps 2120, 2130. Also, an antenna implemented in accordance with antennas 2000 and 2100 can include or exclude one or more of the slot radiating elements shown in FIGS. 20 and 21.

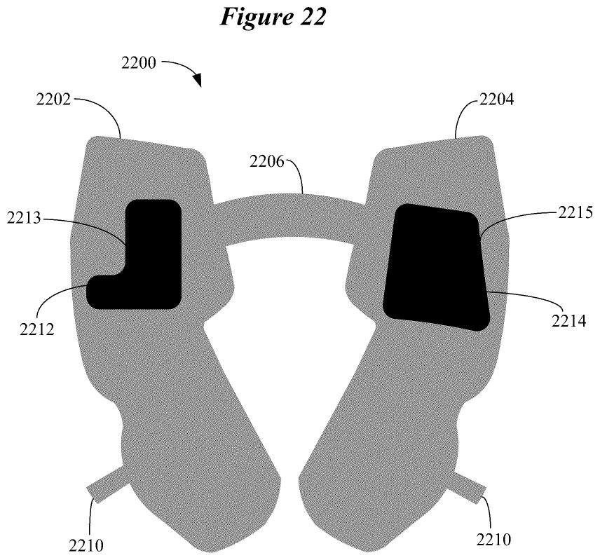

FIG. 22 illustrates an antenna 2200 which includes slot radiating elements in accordance with various embodiments. The antenna 2200 includes a first antenna element 2202 comprising a slot radiating element 2212, and a second antenna element 2204 comprising a slot radiating element 2214. A strap 2206 is connected to, and extends between, the first and second antenna elements 2202, 2204. A feedpoint 2210 is coupled to the first and second antenna elements 2202, 2204 and a radio of the hearing device. In the embodiment shown in FIG. 22, each of the slot radiating elements 2212, 2214 is filled with a dielectric or magnetic material 2213, 2215. The material 2213, 2215 filling the slot radiating elements 2212, 2214 changes the electric and/or magnetic fields inside the slot radiating elements 2212, 2214. By changing the permittivity or permeability of the space inside the slot radiating elements 2212, 2214, the fields inside the slots 2212, 2214 also change, based on the electric and magnetic properties of the material 2213, 2215. Because these fields inside the slot radiating elements 2212, 2214 also give rise to radiation, changing the electric and/or magnetic field serves to modify the performance of the antenna 2200, including the input impedance and the radiation efficiency. The type, amount, and distribution of the dielectric or magnetic material 2213, 2215 can be selected to achieve desired radiation efficiency, input impedance, and other performance parameters of the antenna 2200.

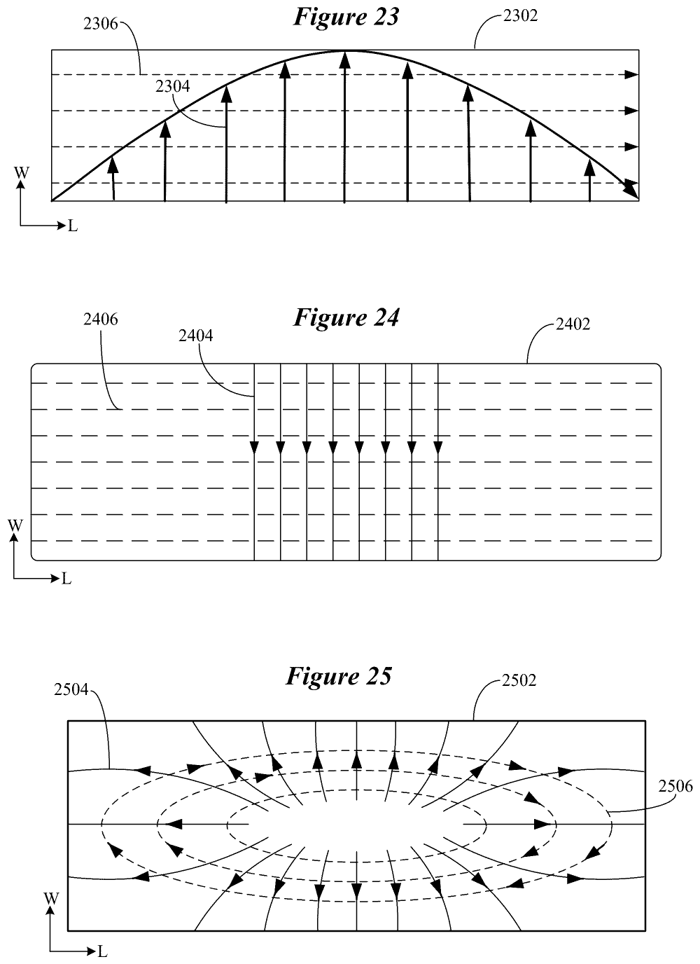

In general, and with reference to FIG. 23, a slot radiating element according to various embodiments is created by cutting or otherwise providing a slot 2302 in an existing antenna (not shown), such as a bowtie-type or other type of antenna. Electromagnetic theory dictates the performance of the slot 2302, which is based on the size and shape of the aperture and the driving frequency. Electric and magnetic fields are created in the slot 2302 when it is excited, and these fields are what gives rise to the radiation distribution pattern. It is understood that incorporating a slot 2302 in an existing antenna, such as a bowtie antenna, is notably distinct from a slot fed antenna. One of ordinary skill in the art would understand that a bowtie antenna that incorporates one or more radiating slots is fundamentally different from a bowtie antenna created out of the slot.

FIG. 23 shows the slot 2302 having a rectangular shape with electric and magnetic fields illustrated within the slot 2302. More particularly, the solid vertical lines 2304 illustrate the electric field, and the dashed horizontal lines 2306 illustrate the magnetic field. In the case of symmetrical excitation of the slot 2302, the voltage reaches its maximum at the center of the slot 2302, and is at a minimum at the edges of the slot 2302. Contrastingly, the current is negative at one edge of the slot 2302, reaches zero at the center, and is positive at the other edge of the slot 2302.

The slot 2302 has a length, L, and a width, W. According to various embodiments, a typical slot 2302 incorporated in an antenna of a hearing device has a length, L, of about λ/10, where the antenna is configured to operate in a frequency range of about 2.4 GHz to about 2.48 GHz. In some embodiments, the slot 2302 has a length, L, of about λ/20 to about λ/10, where the antenna is configured to operate in a frequency range of about 2.4 GHz to about 2.48 GHz.

The width, W, is generally smaller than the length, L, of the slot 2302. The minimum ratio of L:W for the slot 2302 to be excited is 1:1, which would be represented by a square or a circle. The maximum ratio of L:W is limited by the hearing device size and the manufacturability of the slot 2302 (e.g., how small a width, W, of the slot 2302 can be manufactured). This maximum ratio is approximately 200:1, which can be represented by a one-inch long antenna with a 0.005 inch wide slot 1302. Examples of useful L-to-W ratios of slot 1302 include 1:1, 1.5:1, 2:1, 2.5:1, and 3-5:1. Other useful L-to-W ratios of slot 2302 include 5-10:1, 10-20:1, 20-50:1, 50-80:1, 80-120:1, 120-160:1, and 160-200:1.

According to various embodiments, a slot radiating element can be excited with the variety of different modes. For example, a slot radiating element can be excited with various transverse electric (TE) modes and various transverse magnetic (TM) modes. FIG. 24 shows a slot radiating element with a slot 2402 having a rectangular shape in accordance with various embodiments. In FIG. 24, the slot 2402 is excited by a TE mode, such as a TE₁₀ mode. When the slot 2402 is excited by the TE₁₀ mode, the electric field (illustrated by solid vertical lines 2404) is perpendicular to the direction of signal propagation, and the magnetic field (illustrated by dashed horizontal lines 2406) is in the direction of signal propagation. FIG. 25 shows a slot radiating element with a slot 2502 having a rectangular shape in accordance with various embodiments. In FIG. 25, the slot 2502 is excited by a TM mode, such as a TM₁₁ mode. When the slot 2502 is excited by the TM₁₁ mode, the magnetic field (illustrated by dashed lines 2506) is perpendicular to the direction of signal propagation, and the electric field (illustrated by solid lines 2504) is in the direction of signal propagation. These and other modes (e.g., higher TE and TM modes) are contemplated.

This document discloses numerous embodiments, including but not limited to the following:

Item 1 is an ear-worn electronic device configured to be worn by a wearer, comprising: an enclosure configured to be supported by, in or on an ear of the wearer; electronic circuitry disposed in the enclosure and comprising a wireless transceiver; and an antenna disposed in or on the enclosure and coupled to the wireless transceiver via a feedline, the antenna comprising: two antenna elements each comprising electrically conductive material and having an area greater than an area of the feedline, the two antenna elements oriented substantially in opposition to one another and at least some of the electronic circuitry disposed between the two antenna elements; at least one strap connected to and between the two antenna elements; and at least one slot radiating element incorporated in at least one of the two antenna elements and the at least one strap.

Item 2 is the device of item 1, wherein the at least one slot radiating element is configured to radiate with the two antenna elements to contribute to an electric field generated by the antenna.

Item 3 is the device of item 1, wherein the antenna is configured such that currents flowing through the two antenna elements via the feedline excite the two antenna elements and the at least one slot radiating element.

Item 4 is the device of item 1, wherein the antenna comprises at least one slot radiating element incorporated in each of the two antenna elements.

Item 5 is the device of item 1, wherein the antenna comprises at least one slot radiating element incorporated in one of the two antenna elements and the at least one strap.

Item 6 is the device of item 1, wherein the antenna comprises at least one slot radiating element incorporated in each of the two antenna elements and the at least one strap.

Item 7 is the device of item 1, wherein: the at least one slot radiating element reduces an effective aperture of the antenna; and the at least one slot radiating element is configured to increase a radiation efficiency of the antenna notwithstanding the at least one slot radiating element reduces the effective aperture of the antenna.

Item 8 is the device of item 1, wherein a dielectric material or a magnetic material is disposed within the at least one slot radiating element.

Item 9 is the device of item 1, wherein the at least one slot radiating element has a generally regular or irregular polygonal shape comprising a regular or irregular square, rectangle, triangle, quadrilateral, trapezoid, rhombus, parallelogram, kite, pentagon, hexagon, heptagon, octagon, nonagon, decagon or dodecagon, or a combination of any of these shapes.

Item 10 is the device of item 1, wherein the at least one slot radiating element has a generally curved or curvilinear shape comprising a circle, oval, ellipse, crescent, quatrefoil, curvilinear polygon, an arbitrary closed curve, or a combination of any of these shapes.

Item 11 is the device of item 1, wherein the wireless transceiver and the antenna are configured to operate in a frequency range of about 2.4 GHz to about 2.48 GHz.

Item 12 is an ear-worn electronic device configured to be worn by a wearer, comprising: an enclosure configured to be supported by, in or on an ear of the wearer; electronic circuitry disposed in the enclosure and comprising a wireless transceiver; and an antenna disposed in or on the enclosure and coupled to the wireless transceiver via a feedline, the antenna comprising: two operably coupled antenna elements each comprising electrically conductive material and having an area greater than an area of the feedline, the two antenna elements oriented substantially in opposition to one another and at least some of the electronic circuitry disposed between the two antenna elements; and at least one slot radiating element incorporated in at least one of the two antenna elements and configured such that excitation of the antenna excites a slot mode of the at least one slot radiating element.

Item 13 is the device of item 12, wherein the at least one slot radiating element is incorporated in each of the two antenna elements.

Item 14 is the device of item 12, wherein the at least one slot radiating element is configured to radiate with the two antenna elements to contribute to an electric field generated by the antenna.

Item 15 is the device of item 12, wherein: the at least one slot radiating element reduces an effective aperture of the antenna; and the at least one slot radiating element is configured to increase a radiation efficiency of the antenna notwithstanding the at least one slot radiating element reduces the effective aperture of the antenna.

Item 16 is the device of item 12, wherein a dielectric material or a magnetic material is disposed within the at least one slot radiating element.

Item 17 is the device of item 12, wherein the slot mode of the at least one slot radiating element comprises a transverse electric mode.

Item 18 is the device of item 12, wherein the slot mode of the at least one slot radiating element comprises a transverse magnetic mode.

Item 19 is the device of item 12, wherein the at least one slot radiating element comprises an N-sided polygon, where N>=3.

Item 20 is the device of item 12, wherein the at least one slot radiating element has a generally curved or curvilinear shape comprising a circle, oval, ellipse, crescent, quatrefoil, curvilinear polygon, an arbitrary closed curve, or a combination of any of these shapes.

Item 21 is the device of item 12, wherein the wireless transceiver and the antenna are configured to operate in a frequency range of about 2.4 GHz to about 2.48 GHz.

Although reference is made herein to the accompanying set of drawings that form part of this disclosure, one of at least ordinary skill in the art will appreciate that various adaptations and modifications of the embodiments described herein are within, or do not depart from, the scope of this disclosure. For example, aspects of the embodiments described herein may be combined in a variety of ways with each other. Therefore, it is to be understood that, within the scope of the appended claims, the claimed invention may be practiced other than as explicitly described herein.

All references and publications cited herein are expressly incorporated herein by reference in their entirety into this disclosure, except to the extent they may directly contradict this disclosure. Unless otherwise indicated, all numbers expressing feature sizes, amounts, and physical properties used in the specification and claims may be understood as being modified either by the term “exactly” or “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein or, for example, within typical ranges of experimental error.

The recitation of numerical ranges by endpoints includes all numbers subsumed within that range (e.g. 1 to 5 includes 1, 1.5, 2, 2.75, 3, 3.80, 4, and 5) and any range within that range. Herein, the terms “up to” or “no greater than” a number (e.g., up to 50) includes the number (e.g., 50), and the term “no less than” a number (e.g., no less than 5) includes the number (e.g., 5).

The terms “coupled” or “connected” refer to elements being attached to each other either directly (in direct contact with each other) or indirectly (having one or more elements between and attaching the two elements). Either term may be modified by “operatively” and “operably,” which may be used interchangeably, to describe that the coupling or connection is configured to allow the components to interact to carry out at least some functionality (for example, a radio chip may be operably coupled to an antenna element to provide a radio frequency electromagnetic signal for wireless communication).

Terms related to orientation, such as “top,” “bottom,” “side,” and “end,” are used to describe relative positions of components and are not meant to limit the orientation of the embodiments contemplated. For example, an embodiment described as having a “top” and “bottom” also encompasses embodiments thereof rotated in various directions unless the content clearly dictates otherwise.

Reference to “one embodiment,” “an embodiment,” “certain embodiments,” or “some embodiments,” etc., means that a particular feature, configuration, composition, or characteristic described in connection with the embodiment is included in at least one embodiment of the disclosure. Thus, the appearances of such phrases in various places throughout are not necessarily referring to the same embodiment of the disclosure. Furthermore, the particular features, configurations, compositions, or characteristics may be combined in any suitable manner in one or more embodiments.

The words “preferred” and “preferably” refer to embodiments of the disclosure that may afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the disclosure.

As used in this specification and the appended claims, the singular forms “a,” “an,” and “the” encompass embodiments having plural referents, unless the content clearly dictates otherwise. As used in this specification and the appended claims, the term “or” is generally employed in its sense including “and/or” unless the content clearly dictates otherwise.

As used herein, “have,” “having,” “include,” “including,” “comprise,” “comprising” or the like are used in their open-ended sense, and generally mean “including, but not limited to.” It will be understood that “consisting essentially of,” “consisting of,” and the like are subsumed in “comprising,” and the like. The term “and/or” means one or all of the listed elements or a combination of at least two of the listed elements.

The phrases “at least one of,” “comprises at least one of,” and “one or more of” followed by a list refers to any one of the items in the list and any combination of two or more items in the list.

1-17. (canceled)

18. An ear-worn electronic hearing device configured to be worn by a wearer, comprising:
an enclosure configured to be supported by, at, in or on an ear of the wearer;
electronic circuitry disposed in the enclosure and comprising a wireless transceiver; and
an antenna disposed in or on the enclosure and operably coupled to the wireless transceiver, the antenna having a physical size and defining a plurality of cutouts disposed along a first edge of the antenna, wherein each cutout in the plurality of cutouts extends in a height or length direction less than half of a physical distance from the first edge of the antenna to a second edge of the antenna opposite the first edge of the antenna, and the antenna further defines a slot radiating element.

19. The ear-worn electronic hearing device of claim 18, wherein the cutouts are configured to increase an electrical length of the antenna without an increase in the physical size of the antenna relative to the antenna devoid of the cutouts.

20. The ear-worn electronic hearing device of claim 18, wherein at least one of the first edge or the second edge is an internal edge of the antenna.

21. The ear-worn electronic hearing device of claim 18, wherein at least one of the first edge or the second edge is an external edge of the antenna.

22. The ear-worn electronic hearing device of claim 18, wherein the plurality of cutouts is a first plurality of cutouts, and the antenna defines a second plurality of cutouts disposed along the second edge, wherein each cutout in the second plurality of cutouts extends in a height or length direction less than half of the physical distance from the second edge to the first edge.

23. The ear-worn electronic hearing device of claim 22, wherein the first plurality of cutouts extends in a height direction, and the antenna defines a third plurality of cutouts disposed along a third edge of the antenna, wherein each cutout in the third plurality of cutouts extends in a width direction less than half a physical distance from the third edge to a fourth edge of the antenna opposite the third edge of the antenna.

24. The ear-worn electronic hearing device of claim 18, wherein:
the antenna comprises an antenna element disposed on a substrate comprising electrically insulating material; and
each of the cutouts defines a void in an electrically conductive material with the substrate extending across the void.

25. The ear-worn electronic hearing device of claim 18, wherein the cutouts are configured to increase a length of a path of current distribution along a periphery of the antenna relative to the antenna devoid of the cutouts.

26. The ear-worn electronic hearing device of claim 18, wherein:
the cutouts reduce a surface area of the antenna relative to the antenna devoid of the cutouts; and
the cutouts are configured to increase a radiation efficiency of the antenna relative to the antenna devoid of the cutouts notwithstanding a reduction in the surface area of the antenna.

27. The ear-worn electronic hearing device of claim 18, wherein at least one of:
the cutouts are configured to increase an impedance bandwidth of the antenna relative to the antenna devoid of the cutouts, or
the cutouts are configured to modify one or both of an impedance and a resonance frequency of the antenna.

28. The ear-worn electronic hearing device of claim 18, wherein the cutouts include cutouts having a polygonal shape, a generally curved or curvilinear shape, a hammer shape, a star shape, a sawtooth shape, a round shape, an oval shape, an elliptical shape, or a lollipop shape.

29. The ear-worn electronic hearing device of claim 18, wherein the slot radiating element has a rectangular shape.

30. The ear-worn electronic hearing device of claim 18, wherein, for each cutout of the plurality of cutouts, a depth of the cutout is less than 25% of a distance from an outer opening of the cutout to an edge of the antenna opposite the cutout.

31. The ear-worn electronic hearing device of claim 18, wherein:
the antenna comprises:
a first antenna element and a second antenna element each comprising electrically conductive material and oriented substantially in opposition to one another, at least some of the electronic circuitry disposed between the first antenna element and the second antenna element; and
at least one conductive strap connected to and between the first antenna element and the second antenna element,
the plurality of cutouts is disposed along a periphery of the first antenna element, and
the slot radiating element is defined in the first antenna element.

32. The ear-worn electronic hearing device of claim 31, wherein:
the plurality of cutouts is a first plurality of cutouts,
the slot radiating element is a first slot radiating element,
a second plurality of cutouts is disposed along a periphery of the second antenna element, wherein each cutout in the second plurality of cutouts extends in a height or length direction less than half of a physical distance from a third edge of the second antenna element to a fourth edge of the second antenna element opposite the third edge of the second antenna element, and
the second antenna element defines a second slot radiating element.

33. The ear-worn electronic hearing device of claim 31, wherein the at least one conductive strap defines a third slot radiating element.

34. The ear-worn electronic hearing device of claim 31, wherein the at least one conductive strap is a first conductive strap and the antenna further comprises a second conductive strap connected to and between the first antenna element and the second antenna element.

35. The ear-worn electronic hearing device of claim 18, wherein the slot radiating element is configured to be excited by a transverse electric mode, wherein when the slot radiating element is excited by the transverse electric mode, an electric field is perpendicular to a direction of signal propagation and a magnetic field is in the direction of the signal propagation.

36. The ear-worn electronic hearing device of claim 18, wherein the slot radiating element is configured to be excited by a transverse electric mode, wherein when the slot radiating element is excited by the transverse electric mode, an electric field is in a direction of signal propagation and a magnetic field is perpendicular to the direction of the signal propagation.

37. The ear-worn electronic hearing device of claim 18, wherein the slot radiating element has a length that is one of: λ/10 or λ/20, where λ is a frequency in a frequency range within which the antenna is configured to operate.
